(19) United States
(12) Patent Application Publication
(10) Pub. No.: US 2005/0053270 A1
(43) Pub. Date: Mar. 10, 2005

(54) Image processing apparatus and signal processing apparatus

(75) Inventors: Satoshi Kasai, Tokyo (JP); Tsuyoshi Kobayashi, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 10/932,938

(22) Filed: Sep. 2, 2004

(30) Foreign Application Priority Data
Sep. 5, 2003 (JP) 2003-313855
Sep. 5, 2003 (JP) 2003-313882

(51) Int. Cl. G06K 9/00; G06K 9/46

(52) U.S. Cl. 382/128; 382/190

(57) ABSTRACT

An image processing apparatus includes a feature value calculating section for setting a certain pixel in a processing target image as a pixel of interest, and for calculating a curvature of a curved surface which is obtained from density distribution of adjacent pixels which are located within a predetermined range from the pixel of interest, as a feature value of an image area within the predetermined range from the pixel of interest.

### BACKGROUND OF THE INVENTION

1. Field of the Invention

The invention relates to an image processing apparatus which calculates a feature value of an image having density distribution, and also relates to a signal processing apparatus which calculates a feature value of signals forming a curved surface.

2. Description of Related Art

In a medical field, digitization of medical images is achieved. According to the digitization, medical image data generated by a CR (Computed Radiography) apparatus or the like is displayed on a monitor, and diagnosis is done with a doctor reading the displayed medical image on the monitor, to observe a state of a lesion and a change of the same with time.

So far, for the purpose of reducing burdens of a doctor who reads images, what has been developed is a medical signal processing apparatus called Computer-Aided Diagnosis (hereinafter, it is referred to as CAD) which automatically detects a lesion which appears on the image as an abnormal shadow candidate, by image-processing the above-mentioned medical image data.

A lesion often has characteristic density distribution. Based on such density characteristic, CAD is used to detect an image area which is estimated to be a lesion, as an abnormal shadow candidate. For example, as a characteristic cancerous part of breast cancer, mass and clustered-microcalcification can be cited. On a medical image on which a mamma is generated or radiographed (it is called mammography), mass shadow appears as whitish circled shadow having density variation which is close to Gaussian distribution. On the contrary, since clustered-microcalcification exists as a gathered (clustered) microcalcification parts, it appears as whitish circled shadow having density variation which is approximately in a conic structure fashion.

For the above-mentioned CAD, various types of detecting algorithms are developed according to types of lesions which are detection targets. As an optimum algorithm to detect mass shadow, a method using the Iris filter is proposed (for example, see Japanese Patent Application Publication (Unexamined) No. Tokukaihei 8-263641 and Japanese Patent Application Publication (Unexamined) No. Tokukaihei 10-91758). As an optimum algorithm to detect clustered-microcalcification, a method using the morphology filter and the like is proposed.

However, since the Iris filter in general strongly responds to an area having a circled shape with lower density than the other part, if mammary gland which has high circularity appears in a massive fashion on an image, there is a case of detecting mammary gland of normal tissue as abnormal shadow by mistake. Similarly, if a high frequency signal such as noise is generated on an image, since signal variation of noise is similar to that of clustered-microcalcification, it is not easy to distinguish the difference thereof. Thereby, there is a case of detecting a noise area by mistake.

Further, if image signals are comprehended as three-dimensional signals having density component, the image signals construct a curved surface which indicates density distribution. Since abnormal shadow has density variation in the above-mentioned conic structure shape or the like, a signal area of the abnormal shadow supposedly forms a characteristic curved surface. However, although a method of detecting abnormal shadow based on density characteristic, such as a method of detecting concentration of density gradient with respect to a pixel of interest with the use of the Iris filter or the like, is developed, there has been no proposal of a method of detecting in consideration of a shape of the curved surface according to density distribution of shadow.

Further, clustered-microcalcification shadow in general appears with some spreading on which there are clustered spotted shadows having low density. However, there has been no proposal of a method to detect abnormal shadow candidates in consideration of a regional characteristic.

Further, what is still an important object is, not only how to detect an abnormal shadow candidate area in a medical image, but also how to detect a specific image area as a detection target in the entire image analysis or how to detect a specific signal in the entire signal analysis, and to eliminate noise component accurately.

### SUMMARY OF THE INVENTION

The present invention has a first object to improve detection accuracy for detecting an image area as a detection target in a processing target image, and a second object to accurately detect a specific signal of a detection target from a signal of a processing target by distinguishing the specific signal from other signals.

In order to achieve the above-mentioned objects, in accordance with a first aspect of the present invention, an image processing apparatus comprises a feature value calculating section for setting a certain pixel in a processing target image as a pixel of interest, and for calculating a curvature of a curved surface which is obtained from density distribution of adjacent pixels which are located within a predetermined range from the pixel of interest, as a feature value of an image area within the predetermined range from the pixel of interest.

According to the above-mentioned apparatus, a curvature of a curved surface obtained from density distribution of pixels within a predetermined range around a pixel of interest is calculated as a feature value. Therefore, it is possible to estimate a curved surface shape from the feature value including the calculated curvature. Accordingly, it is possible to accurately detect an image area as a detection target which forms a characteristic curved surface shape from other areas in a processing target image, and thereby, it is possible to improve the detection accuracy.

Preferably, the processing target image comprises a medical image, the feature value calculating section sets each pixel of the medical image as the pixel of interest, and calculates each curvature with respect to each pixel of interest as the feature value, and the apparatus comprises an abnormal shadow candidate detecting section for detecting an area within the predetermined range from the pixel of interest as a candidate area of abnormal shadow, based on the feature value including each curvature calculated by the feature value calculating section with respect to each pixel of interest.

According to the above-mentioned apparatus, each curvature is calculated by setting each pixel in the detection target area of an abnormal shadow candidate as a pixel of interest, and a candidate area of abnormal shadow is detected based on the feature value including each curvature. Therefore, it is possible to accurately detect abnormal shadow which has characteristic density distribution from other image areas, and thereby it is possible to improve the detection accuracy of an abnormal shadow candidate. Further, it is possible to scan all the detection target areas, and thereby it is possible to improve the detecting accuracy.

Preferably, the processing target image comprises a medical image, the apparatus comprises an abnormal shadow candidate detecting section for detecting a candidate area of abnormal shadow of the medical image, the feature value calculating section sets the pixel of interest within the candidate area of the abnormal shadow detected by the abnormal shadow candidate detecting section and calculates the curvature, and the apparatus comprises an abnormal shadow candidate determining section for judging whether the candidate area of the abnormal shadow detected by the abnormal shadow candidate detecting section is true positive or not based oh the feature value calculated by the feature value calculating section, and for outputting all candidate areas which are judged true positive as a detection result of an abnormal shadow candidate.

More preferably, the feature value calculating section sets a center of the candidate area of the abnormal shadow detected by the abnormal shadow candidate detecting section as the pixel of interest, and calculates the curvature thereof, and the abnormal shadow candidate determining section judges whether the candidate area of the abnormal shadow detected by the abnormal shadow candidate detecting section is true positive or not, based on the curvature calculated by the feature value calculating section.

According to the above-mentioned apparatus, a pixel of interest is set to the center of a candidate area detected by the abnormal shadow candidate detecting section, and whether it is true positive abnormal shadow or not is judged. Therefore, it is possible to improve the detection accuracy with the two-steps detection. Further, by detecting a candidate, it is possible to narrow down a detection target area when a candidate is to be determined. Therefore, it is possible to improve the processing efficiency at the time of determining a candidate.

Preferably, the feature value calculating section changes a range of the curved surface, within which the feature value including the curvature is to be calculated, and calculates curvatures within each changed range.

According to the above-mentioned apparatus, a range within which the feature value is to be calculated is changed, and the curvature is calculated within the changed range. Therefore, it is possible to do the detection in consideration of regional characteristic of density variation, and thereby it is possible to improve the detection accuracy.

Preferably, the feature value calculating section calculates all the curvatures corresponding to each changed range as the feature value.

According to the above-mentioned apparatus, by using all the calculated curvatures corresponding to each changed range as feature values, it is possible to detect an image area as a detection target. Therefore, it is possible to do the detection including detailed density variation, and thereby it is possible to improve the detection accuracy.

Preferably, the feature value calculating section calculates at least one of the curvatures corresponding to each changed range as the feature value.

According to the above-mentioned apparatus, it is possible to detect an image area as a detection target by using any one of the curvatures calculated within each changed range as a feature value. Therefore, it is possible to make the time for the detection shorter than the case of doing the detection using all the calculated curvatures, and thereby it is possible to improve the detection efficiency.

Preferably, the feature value calculating section changes a range of the curved surface within which the feature value is to be calculated, according to at least one of a type and a size of abnormal shadow to be detected.

According to the above-mentioned apparatus, the range is changed according to a type and/or a size of abnormal shadow as a detection target. Therefore, it is possible to handle shadow having various types of sizes.

Preferably, by using a normal line at the pixel of interest as an axis, the feature value calculating section rotates a normal plane determined by the normal line as much as a predetermined angle, and the feature value calculating section calculates an approximate circle which approximates a curved surface shape which is cut out from the curved surface by the normal plane within the predetermined range from the pixel of interest, and the feature value calculating section calculates the curvature based on a radius of the approximate circle.

According to the above-mentioned apparatus, the curvature can be calculated from a radius of an approximate circle which approximates a curved surface shape cut out by the normal plane from a curved surface within a predetermined range from the pixel of interest, at each rotation angle obtained by rotating the normal plane.

Preferably, when the approximate circle is to be calculated, pixels are extracted among all pixels that form the curved surface within the predetermined range, and the approximate circle is calculated by using the extracted pixels.

According to the above-mentioned apparatus, when an approximate circle is to be calculated, it is possible to do the approximation by extracting pixels to be used for calculating the approximate circle. In this way, by calculating an approximate circle with some pixels deducted, the approximation becomes rougher and thereby it is possible to extract low frequency component by cutting out high frequency component. Therefore, by detecting an image area as a detection target based on the curvature calculated from the radius of the approximate circle which is calculated by deducting some pixels, it is possible to do the detection in consideration of frequency characteristic of the image.

Preferably, the feature value calculating section calculates all curvatures calculated from the rotated normal plane at each rotation angle as the feature value.

According to the above-mentioned apparatus, it is possible to detect an image area as a detection target by using all the curvatures corresponding to each rotation angle as feature value. Therefore, it is possible to do the detection including detailed density variation, and thereby it is possible to improve the detection accuracy.

Preferably, the feature value calculating section calculates at least one of curvatures calculated from the rotated normal plane at each rotation angle as the feature value.

According to the above-mentioned apparatus, it is possible to detect an image area as a detection target by using some of all the curvatures corresponding to each rotation angle as a feature value. Therefore, it is possible to make the time for the detection shorter than the case of doing the detection using all the calculated curvatures, and thereby it is possible to improve the detection efficiency.

Preferably, the feature value calculating section sets the pixel of interest in all image areas of the processing target image to calculate the feature value.

According to the above-mentioned apparatus, the feature value including the curvature is calculated by setting a pixel of interest in all the image areas of the processing target image. Therefore, it is possible to do the detection based on the details of all the image areas, and thereby it is possible to improve the detection accuracy even more.

Preferably, the image processing apparatus further comprises: an estimating section for estimating a curved surface shape based on the feature value including the curvature calculated by the feature value calculating section; and a notifying section for giving information of the estimated curve shape.

According to the above-mentioned apparatus, a curved surface shape is estimated based on the feature value including the curvature, and information of the estimated curved surface shape is given. Therefore, it is possible to confirm what sort of density variation the image area within which the curvature is calculated has.

In accordance with a second aspect of the present invention, a signal processing apparatus comprises: a function calculating section for setting a certain signal among processing target signals which form a curved surface as a signal of interest, and for calculating an approximate function which approximates the curved surface within a predetermined range from the signal of interest; and a feature value calculating section for calculating a feature value of signals within the predetermined range within which the approximate function is to be calculated, based on a coefficient which determines the approximate function calculated by the function calculating section.

Preferably, the feature value calculating section calculates a curvature as the feature value, from a coefficient of the approximate function calculated by the function calculating section.

According to the above-mentioned apparatus, an approximate function which approximate a curved surface within a predetermined range around a pixel of interest is calculated, and a curvature is calculated as a feature value of signals within the predetermined range with the use of coefficients of the approximate function. Therefore, it is possible to estimate a curved surface shape from the calculated the feature value including the curvature. Accordingly, it is possible to distinguish signals of a detection target forming a characteristic curved surface shape, from the other signals, and thereby it is possible to do the detection accurately. For example, from medical image signals forming a curved surface of density distribution, it is possible to detect an image signal area of abnormal shadow, which has a characteristic curved surface shape of density distribution, or the like.

Preferably, the function calculating section calculates a plurality of approximate functions which approximate the curved surface within the predetermined range from the signal of interest, and the feature value calculating section calculates the feature value from each of the calculated plurality of approximate functions.

According to the above-mentioned apparatus, a plurality of approximate functions are calculated with respect to a curved surface, and the feature values including curvatures are calculated from each calculated approximate function. Therefore, it is possible to detect a signal of a detection target by using a plurality of feature values.

Preferably, the function calculating section changes a range within which the plurality of approximate functions are to be calculated and calculates the plurality of approximate functions within each changed range, and the feature value calculating section calculates the feature value from each of the calculated plurality of approximate functions within each range.

According to the above-mentioned apparatus, a range within which an approximate function is to be calculated is changed, and the feature value including curvatures is calculated according to coefficients of the approximate function calculated at each changed range. Therefore, it is possible to detect a specific signal of a detection target by using a plurality of feature values calculated at each changed area. Accordingly, it is possible to do the signal detection in consideration of regional characteristic of signal variation, and thereby it is possible to improve the accuracy of the signal detection. Further, by changing a range from a pixel of interest within which a curvature is to be calculated, it is possible to use information of pixels away from the pixel of interest. Therefore, it is possible to expect to obtain information close to the frequency component.

Preferably, the function calculating section changes a degree for calculating the plurality of approximate functions corresponding to each changed degree, and the feature value calculating section calculates the feature value from each of the calculated plurality of approximate functions corresponding to each degree.

According to the above-mentioned apparatus, by changing the degree of an approximate function, the feature value including curvatures is calculated from approximate functions corresponding to each degree, and it is possible to detect a specific signal of a detection target by using the calculated plurality of feature values. In general, as the degree of an approximate function becomes higher, the accuracy of approximation improves, and therefore, higher frequency component appears on an approximate curved surface. Accordingly, it is possible to do the signal detection in consideration of signal frequency information, and thereby it is possible to improve the accuracy of signal detection.

Preferably, the feature value calculating section calculates the curvature and calculates information regarding the calculated curvature to be used as the feature value.

According to the above-mentioned apparatus, it is possible to calculate a new feature value according to calculated curvatures.

Preferably, the function calculating section calculates the approximate function according to a least squares method.

According to the above-mentioned apparatus, it is possible to calculate an approximate function according to the least squares method.

Preferably, the approximate function calculated by the function calculating section according to the least squares method comprises a multidimensional polynomial function.

More preferably, the feature value calculating section calculates the feature value by using at least one of or all of coefficients of a second degree term, a first degree term and a constant term of the multidimensional polynomial function.

According to the above-mentioned apparatus, since an approximate function calculated according to the least squares method is a multidimensional polynomial function, it is possible to calculate the feature value including curvatures by using coefficients of the second term, the first term and the constant term of the multidimensional polynomial function.

Preferably, the processing target signals comprise image signals.

According to the above-mentioned apparatus, it is possible to use an image signal as the processing target. Therefore, it is possible to detect a signal area of a specific image signal which is a detection target, from an image signal.

Preferably, the processing target signals comprise image signals.

According to the above-mentioned apparatus, it is possible to use an image signal of a medical image as the processing target. Therefore, it is possible to detect a signal area of the specific image signal such as an area of an abnormal shadow candidate which is a detection target, from a medical image signal.

Preferably, the apparatus of the second aspect further comprises a detecting section for detecting a signal area which forms a curved surface in a Gaussian distribution or in a conic structure fashion, by using the feature value calculated by the feature value calculating section.

According to the above-mentioned apparatus, by using the feature value including curvatures, it is possible to detect a signal area having characteristic signal variation in a Gaussian distribution or in a conic structure fashion, so as to distinguish it from other signals. For example, a signal area of mass shadow forming a curved surface in a Gaussian distribution or one of clustered-microcalcification shadow forming a curved surface in a conic structure fashion can be detected from a medical image signal.

Preferably, the detecting section detects a signal area of a mass shadow candidate from the medical image signals, by using the feature value calculated by the feature value calculating section.

According to the above-mentioned apparatus, by using the feature value including curvatures, it is possible to detect a signal area of a mass shadow candidate having signal variation in a Gaussian distribution, from a medical image signal.

Preferably, the detecting section detects a signal area of a clustered-microcalcification shadow candidate from the medical image signals, by using the feature value calculated by the feature value calculating section.

According to the above-mentioned apparatus, by using the feature value including curvatures, it is possible to detect a signal area of a clustered-microcalcification shadow candidate having signal variation in a conic structure fashion, from a medical image signal.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is an internal structure of an image processing apparatus according to the first embodiment,

FIG. 2 is a conceptual view showing a curved surface formed by image signals,

FIG. 3 is a conceptual view showing a curved surface of density distribution of a digital image,

FIG. 4 is a view showing signal distribution at a normal section on a normal plane when the curved surface is cut by the normal plane,

FIG. 5 is a view showing an approximate circle at each mask size when changing a parameter of a range for calculating curvature,

FIG. 6 is a view showing shape types of a curved surface according to a combination of a mean curvature and a Gaussian curvature,

FIG. 7 is a flowchart illustrating an abnormal shadow candidate detecting process executed by the image processing apparatus,

FIG. 8 is a flowchart illustrating a candidate detecting process executed within the abnormal shadow candidate detecting process,

FIG. 9 is a flowchart illustrating a candidate determining process executed within the abnormal shadow candidate detecting process,

FIG. 10 is a flowchart illustrating a feature value calculating process executed within the candidate determining process,

FIG. 11 is a view showing a display example of a detection result of an abnormal shadow candidate,

FIG. 12 is a view showing an example of calculating a curvature according to an approximate circle calculated with some image signals deducted,

FIG. 13 is a view showing a functional structure of a signal processing apparatus according to the second embodiment,

FIG. 14A is a view showing a curved surface formed by medical image signals, FIG. 14B is a view showing the curved surface seen in the local coordinate system,

FIG. 15 is a view showing a curved surface of density distribution formed by image signals of a digital medical image,

FIGS. 16A to 16D are views showing curved surfaces which are original signals and approximate functions thereof while a mask size is changed, that is, FIG. 16A is the original signals, FIG. 16B is the approximate function within a mask size 3×3, FIG. 16C is the approximate function within a mask size 5×5, and FIG. 16D is the approximate function within a mask size 7×7,

FIG. 17 is a flowchart illustrating an abnormal shadow candidate detecting process executed by the signal processing apparatus according to the second embodiment,

FIGS. 18A to 18D are views showing curved surfaces which are original signals and approximate functions thereof while a degree of the approximate functions is changed, that is, FIG. 18A is the original signals, FIG. 18B is the approximate function at the second degree, FIG. 18C is the approximate function at the fourth degree, and FIG. 18D is the approximate function at the sixth degree, and

FIG. 19 is a flowchart illustrating an abnormal shadow candidate detecting process executed by the signal processing apparatus according to the third embodiment.

### EMBODIMENTS OF THE INVENTION

Hereinafter, embodiments of the present invention will be described with reference to figures.

### First Embodiment

In the first embodiment, an example in which a pixel of interest is set in image signals of a digital medical image, the image signals forming a curved surface of density distribution, curvatures at the pixel of interest are calculated as a feature value according to image signals within a predetermined range around the pixel of interest, and a signal area of an abnormal shadow candidate is detected based on the calculated feature value will be described.

First, a structure of the first embodiment will be described.

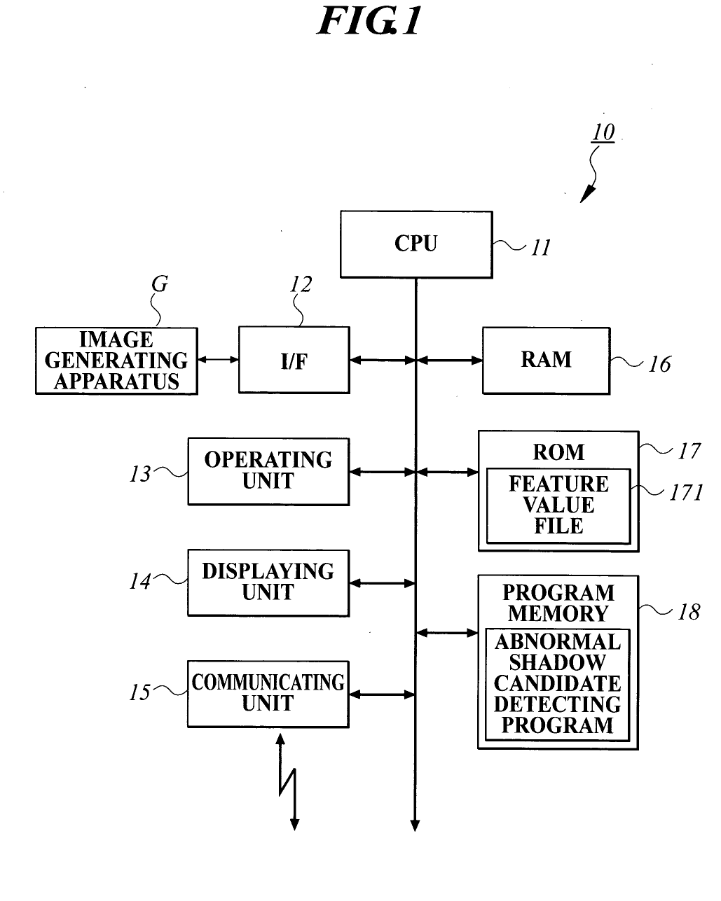

FIG. 1 shows a functional structure of an image processing apparatus 10 according to the first embodiment.

As shown in FIG. 1, the image processing apparatus 10 comprises a CPU (Central Processing Unit) 11, an I/F (InterFace) 12, an operating unit 13, a displaying unit 14, a communicating unit 15, a RAM (Random Access Memory) 16, a ROM (Read Only Memory) 17 and a program memory 18.

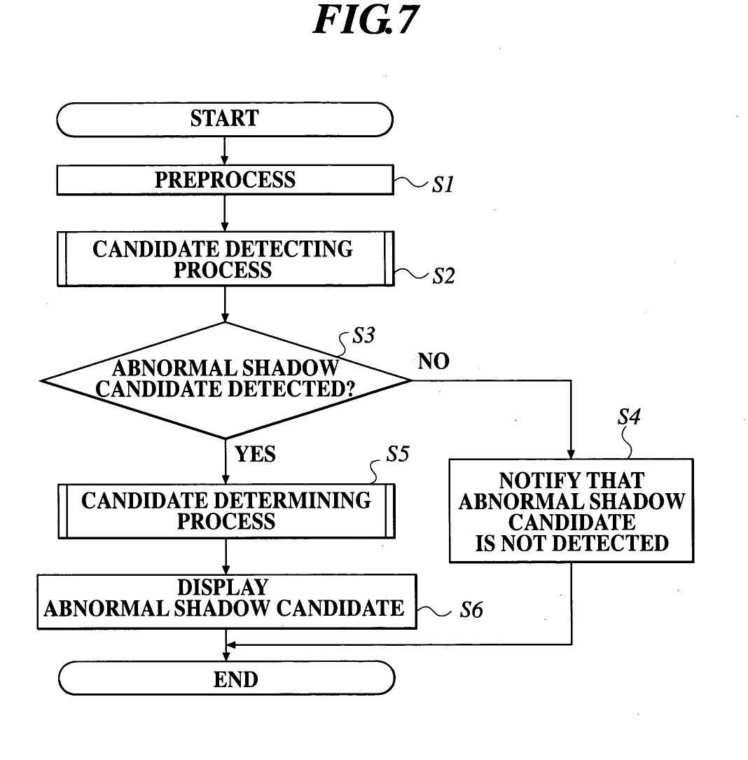

The CPU 11 develops a system program stored in the program memory 18 and an abnormal shadow candidate detecting process program (see FIGS. 7 to 10) according to the present invention, into the RAM 16, and the CPU 11 integrally controls each portion of the image processing apparatus 10 in conjunction with the programs.

Within the abnormal shadow candidate detecting process, a candidate detecting process and a candidate determining process are performed. In the candidate detecting process, a candidate area of abnormal shadow is detected from medical image signals according to a detection algorithm corresponding to a detection target. In the candidate determining process, a curvature is detected as a feature value of the candidate area of abnormal shadow detected in the candidate detecting process, and based on the feature value, whether a candidate area of abnormal shadow detected in the candidate detecting process is true positive or false positive is judged. Then, a candidate area which is judged as true positive is outputted as a detection result of a conclusive abnormal shadow candidate.

Hereinafter, a method of calculating a curvature will be described in detail.

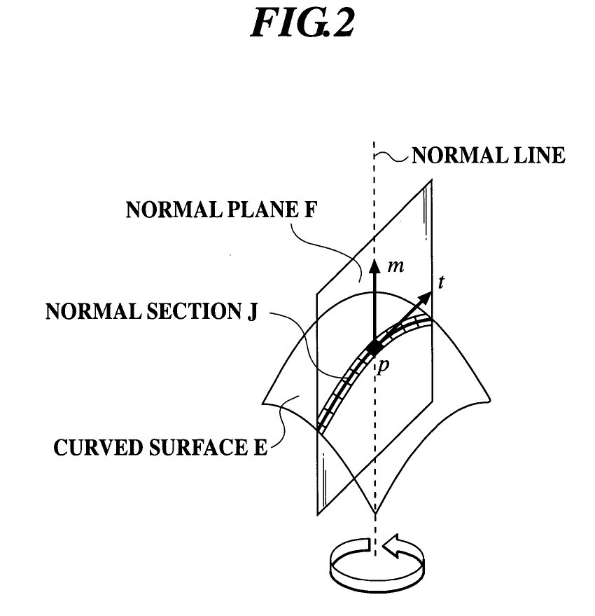

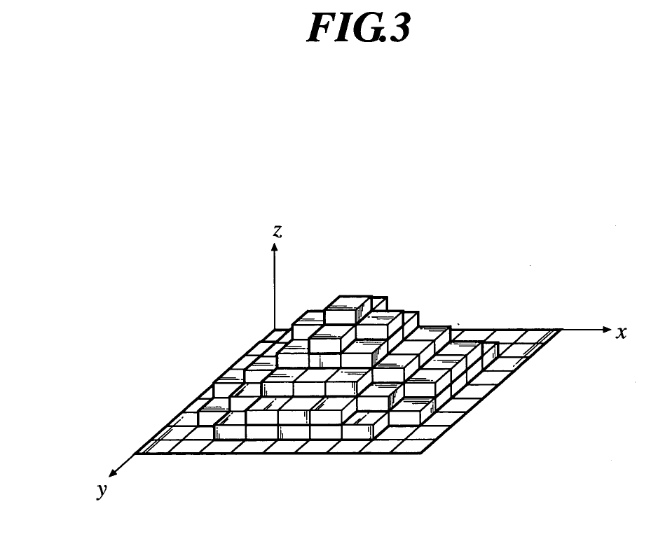

FIG. 2 shows a curved surface E obtained from density distribution of medical image signals which comprise three directions of signal components, which are positions (x direction, y direction) and density (z direction). In FIG. 2, by setting an optional pixel on the curved surface E as a pixel of interest p, a plane determined by a normal vector m at the pixel of interest p is defined as a normal plane F, and a line of intersection between the normal plane F and the curved surface E, that is, a plane in the curved surface E cut out by the normal plane F, is defined as a normal section J. Here, in FIG. 2, for the convenience of description, the curved surface E is illustrated with a smooth surface. In reality, however, since a digital image is to be dealt with, as shown in FIG. 3, the curved surface E has a step-like shape at each pixel, which indicates discrete density values.

A normal curvature at the pixel of interest p on the normal section J determined by the normal plane F can be calculated by approximating a shape of the normal section J (that is, a shape of the curved surface E cut out by the normal plane F) by a circle with the use of pixels near the pixel of interest p, and by calculating a radius of the circle. Here, if the normal plane F is rotated around the normal line as an axis, since a shape of the normal section J is changed according to its rotation angle, a normal curvature to be calculated is also changed.

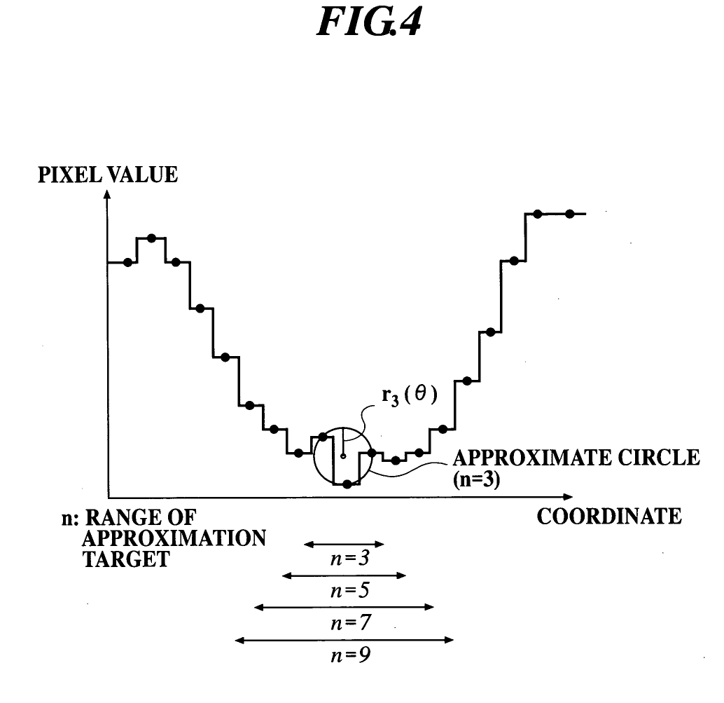

FIG. 4 shows an example of signal distribution at the normal section J determined by the normal plane F rotated as much as a certain rotation angle θ. In FIG. 4, the vertical axis indicates a pixel value (density value), and the horizontal axis indicates a location of the normal plane F in a horizontal direction (a direction perpendicular to the normal line).

For example, if a parameter n of a range of the normal section J to be approximated as a circle is set to 3, based on image signals including the three pixels, which are the pixel of interest p itself and a pixel located at the left side thereof and one located at the right side thereof, the CPU 11 calculates a circle (this is called an approximate circle) which approximates these image signals. When n=3, since there are three points to be used for approximating targets, the approximate circle is a circle passing the three points.

When the approximate circle is calculated, the CPU 11 calculates a radius rₙ(θ), and calculates a normal curvature kₙ(θ) at a rotation angle 0 according to the following equation (1):
kₙ(θ)=1/rₙ(θ) (1)

In this way, with a fixed range n within which an approximate circle is to be calculated, a normal curvature with each rotation angle θ of the normal plane F rotated from 0 to 360 degree is calculated at each predetermined angle, for example at each one degree. Alternatively, calculating time may be reduced by calculating a normal curvature kₙ(θ) at each 5 degree of rotation angle such as 0 degree, 5 degree, 10 degree. Then, among the normal curvatures kₙ(θ) at each rotation angle θ, the maximum value is determined as a maximum curvature kₙ₁, and the minimum value is determined as a minimum curvature kₙ₂.

Then, based on the calculated maximum curvature kₙ₁ and minimum curvature kₙ₂, a mean curvature Hₙ and a Gaussian curvature Kₙ within a mask size n×n are calculated according to the following equations (2) and (3):
Hₙ=½(kₙ₁+kₙ₂) (2)
Kₙ=kₙ₁* kₙ₂ (3)

In other words, by rotating the normal plane F from 0 to 360 degree, it is possible to calculate the maximum curvature kₙ₁, the minimum curvature kₙ₂, the mean curvature Hₙ and the Gaussian curvature Kₙ, of a curved surface within a range of a mask size n×n around the pixel of interest p.

Meanwhile, at the time of calculating the normal curvature kₙ(θ), a size of the approximate circle is changed depending on how much range the image signals within on the normal section J are used as an approximation target. In other words, for example, if a range n of the normal section J within which an approximate circle is to be calculated is changed as 3, 5, 7, . . . , the number of image signals to be used for the approximation is changed. Therefore, the normal curvature kₙ(θ) is also changed.

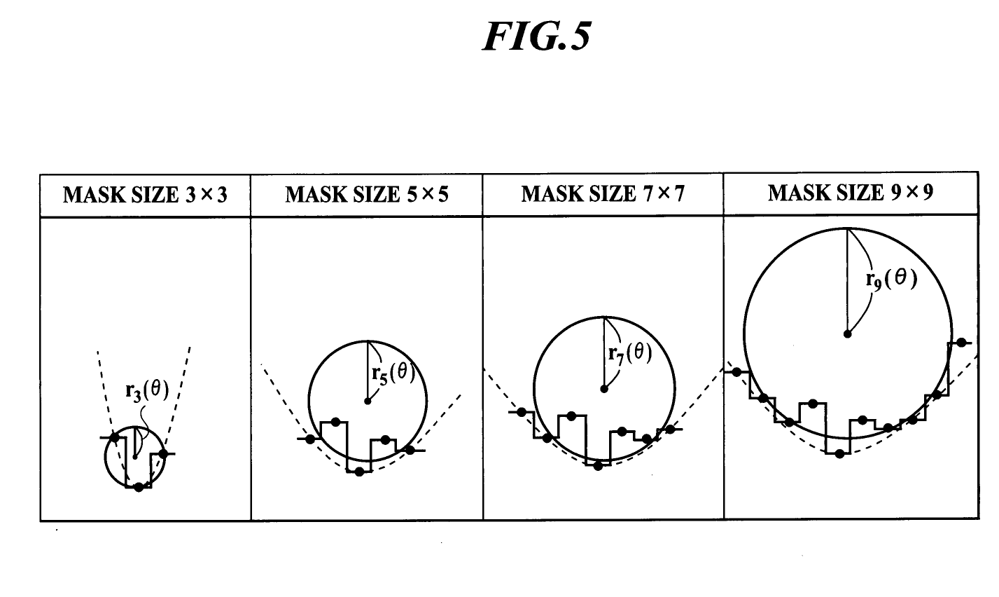

For example, in the signal distribution example shown in FIG. 4, if a parameter n of a range of the approximation target is changed as 3, 5, 7, . . . , since the number of signals to be used for the approximation increases, a size of the approximate circle is changed accordingly as shown in FIG. 5. In general, a curvature is an index value indicating a curving degree, and as a radius of the approximate circle becomes smaller, the curvature becomes larger and it indicates that a curving degree becomes larger. Therefore, in the case of the signal distribution example shown in FIG. 4, as shown in FIG. 5, widening a range makes a radius of the approximate circle larger. Therefore, it is possible to speculate that a curving degree of the normal section J around the pixel of interest p becomes flatter as it is located further from the pixel of interest p.

Accordingly, by widening a range n of image signals which are an approximation target, that is, while a mask size n×n is changed, by calculating various types of curvatures that are a normal curvature kₙ(θ), a maximum curvature kₙ₁, a minimum curvature kₙ₂, a mean curvature Hₙ and a Gaussian curvature Kₙ as a feature value based on the changed mask size n×n, it is possible to detect an abnormal shadow candidate including regional characteristic of density variation.

After the CPU 11 calculates the various types of curvatures within a certain mask size n×n, the CPU 11 changes the parameter n of a mask size to n+2 so as to make a range within which the various types of curvatures are to be calculated one scale larger, and the CPU 11 re-calculates the various types of curvatures within the changed mask size. Here, since a size of shadow differs depending upon a type of abnormal shadow which is a detection target, it is assumed that a maximum mask size is appropriately set according to a type or a size of abnormal shadow which is a detection target.

Then, when the calculation of the various types of curvatures within each changed mask size n×n is completed, each rotation angle, the normal curvature kₙ(θ) calculated at each mask size n×n (0≦θ<360), the maximum curvature kₙ₁, the minimum curvature kₙ₂, the mean curvature Hₙ and the Gaussian curvature Kₙ are inputted to the multivariate analysis as a feature value, and then whether an image area around the pixel of interest p has a high possibility of being true positive abnormal shadow is judged. For example, the various types of curvatures are calculated within a mask size 3×3 by rotating as much as 1 degree at each time, and all the curvatures are obtained by doing the same thing within a mask size 5×5 and a mask size 7×7 sequentially as a feature value, and consequently, a result of the multivariate analysis is derived.

Here, in regard to the normal curvature kₙ(θ), all the values of the normal curvatures calculated within each mask size n×n with each rotation angle θ may be inputted to the multivariate analysis, or some of the values may be extracted to be inputted to the multivariate analysis.

Hereinafter, the multivariate analysis will be described.

The mean curvature Hₙ calculated as a feature value is an index which indicates whether the curved surface as a whole is a reentrant type or a convex type. As a value of Hₙ becomes larger in a positive direction, the curved surface shows a more reentrant shape, and as a value of the Hₙ becomes larger in a negative direction, the curved surface shows a more convex shape. Further, the Gaussian curvature Kₙ is an index which indicates a difficulty of developing the curved surface into a plane. As an absolute value of the Gaussian curvature becomes larger, it is more difficult to develop the curved surface into a plane, and if a value of Kₙ is zero, the curved surface has a shape that can be developed into a plane.

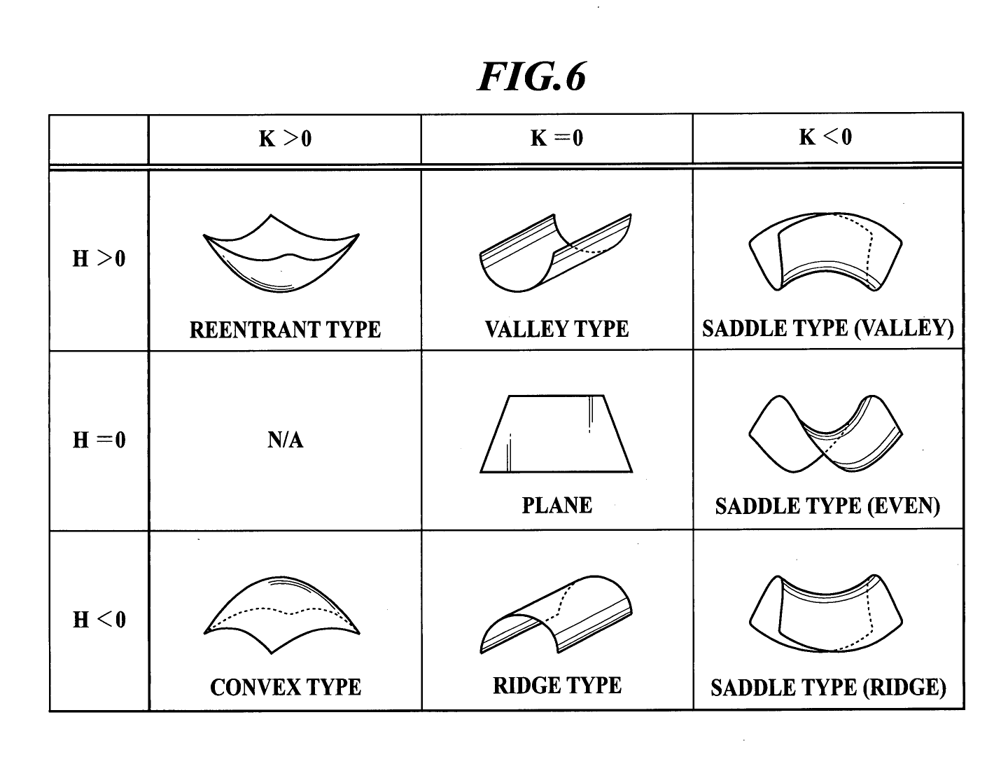

Shapes of the curved surfaces can be classified as shown in FIG. 6 with a combination of the mean curvature Hₙ and the Gaussian curvature Kₙ. As shown in FIG. 6, it is possible to classify shapes of the curved surfaces according to a state of a value being positive or negative of the mean curvature Hₙ and the Gaussian curvature Kₙ. For example, if both Kₙ and Hₙ have positive values, a shape of the curved surface is a reentrant type, and if Kₙ=0 and Hₙ>0, the curved surface is a half-cylindrical convex type, or the like.

If the mean curvature Hₙ and the Gaussian curvature Kₙ in regard to abnormal shadow of clustered-microcalcification and mass shadow are calculated to be classified, both are classified as a reentrant type. In more detail, there is a tendency that, while clustered-microcalcification appears reentrant in a conic fashion, mass shadow appears reentrant in a flat Gaussian distribution. Further, since shadow of mammary gland has a convex shape, it is possible to easily distinguish mammary gland from abnormal shadow such as clustered-microcalcification, mass shadow and the like.

Meanwhile, clustered-microcalcification shadow has a regional characteristic which appears on an image with spotted calcified portions having a spread of approximately 200 μm to 1 mm. Accordingly, there is a high possibility of seeing several pieces of density variation having conic shapes within a certain broad area. Further, mass shadow mostly has a size of approximately 5 mm to 3 cm. Accordingly, it is estimated that density variation in a Gaussian distribution can be seen within a range of 5 mm to 3 cm on the image.

Therefore, the multivariate analysis is structured so that the various types of curvatures that are the normal curvature kₙ(θ), the maximum curvature kₙ₁, the minimum curvature kₙ₂, the mean curvature Hₙ and the Gaussian curvature Kₙ are in advance obtained as a feature value of abnormal shadow, the obtained curvatures are set to the multivariate analysis as index data, and an index value indicating how much characteristic of true positive abnormal shadow is contained is outputted as an output value of the multivariate analysis. Here, as a technique of the multivariate analysis, the artificial neural network, the principal component analysis, the discriminant analysis and the like can be cited, and any one may be used, or another technique may be used.

Then, according to a result of the multivariate analysis, based on the obtained index value, whether an area of a mask size n×n around the pixel of interest p is true positive abnormal shadow or not is judged. For example, the multivariate analysis is structured so that, with mass shadow set as a detection target, how much characteristic of mass shadow is contained is normalized into a value from 0 to 1 to be outputted. The closer to 1 the normalized index value is, the more characteristic of mass shadow is contained. Then, the calculated feature values (various types of curvatures) are inputted to the multivariate analysis to obtain the normalized index value from 0 to 1, and if the index value is more than a threshold value, for example more than 0.7, it is judged as true positive, and if the index value is less than the threshold value 0.7, it is judged as false positive.

If it is judged as true positive according to a result of the multivariate analysis, as the final detection result of an abnormal shadow candidate, the CPU 11 detects an image area within a mask size n×n around the pixel of interest p as a candidate area of abnormal shadow. Meanwhile, if it is judged as false positive, the CPU 11 eliminates the candidate detected by the candidate detecting process which is judged as false positive from the detection result of an abnormal shadow candidate. Then, the CPU 11 displays the detection result of the abnormal shadow candidate judged as true positive, on the displaying unit 13. Concretely, the CPU 11 displays a medical image on the displaying unit 13, so as to distinguish the candidate area detected as true positive abnormal shadow in the medical image.

Further, the CPU 11 estimates a curved surface shape of density distribution of an abnormal shadow candidate area. As shown in FIG. 6, curved surface shapes are classified according to signs of a mean curvature Hₙ and a Gaussian curvature Kₙ. Therefore, the CPU 11 estimates a curved surface shape based on a mean curvature Hₙ and a Gaussian curvature Kₙ calculated from an abnormal shadow candidate area. Then, the CPU 11 displays information of an estimated curved surface shape together with a detection result of the abnormal shadow candidate on the displaying unit 13.

Further, before the detection of an abnormal shadow candidate, the CPU 11 applies various types of image processes on the inputted medical image signals. The various types of image processes include a gradation process for adjusting contrast, a contrast correcting process for magnifying density gradation of a low density area of mammary gland or mass shadow, which tends to have low contrast, and conversely for compressing density gradation of a fat area, which has low possibility of existence of clustered-microcalcification, an unsharpness mask process for adjusting sharpness of an image, a dynamic range compressing process for holding contrast of detail of subject having wide dynamic range within an easily viewable range without degreasing the contrast, and the like.

In other words, according to the collaboration between the abnormal shadow candidate detecting program and the CPU 11, it is possible to realize the feature value calculating section, the abnormal shadow candidate detecting section, the abnormal shadow candidate determining section and the estimating section.

The I/F 12 is an interface for establishing a connection to the image generating apparatus G, and inputs a medical image signal generated by the image generating apparatus G to the image processing apparatus 10.

As the image generating apparatus G, it is possible to apply a laser digitizer which reads a medical image signal by scanning laser beam over a film in which a medical image is recorded, a film scanner which reads a medical image signal recorded in a film by a sensor comprising photoelectric transducers such as CCD (Charge Coupled Device), and the like.

Further, a method for inputting a medical image signal is not limited to reading a medical image recorded in a film. For example, it is possible to connect a radiographing apparatus to the image processing apparatus 10, the radiographing apparatus radiographing a medical image with the use of photostimulable phosphor, or to connect a flat panel detector to the image processing apparatus 10, the flat panel detector comprising condensers and radiation detecting devices which generate electric charge corresponding to intensity of irradiated radiation.

The operating unit 13 comprises a keyboard which has cursor keys, numeric keys and various types of function keys, and outputs an operation signal corresponding to a pushed key to the CPU 11. Here, according to necessity, the operating unit 13 may further comprise a pointing device such as a mouse, a touch panel or the like.

The displaying unit 14 comprises an LCD (Liquid Crystal Display) or the like, and displays a medical image and various types of display information such as a detection result of an abnormal shadow candidate area by the CPU 11 or the like. In other words, by displaying information of a curved surface shape of density distribution which is estimated in an abnormal shadow candidate area on the displaying unit 14, it is possible to realize the notifying section.

The communicating unit 15 comprises an interface for communication such as a network interface card, a modem, a terminal adaptor or the like, and transmits/receives various types of information to/from an external device on the communication network. For example, a medical image signal may be received from the image generating apparatus G through the communicating unit 15, or by establishing a connection to a server or the like within a hospital or a diagnosis terminal placed in each examination room, a detection result of an abnormal shadow candidate may be transmitted through the communicating unit 15.

The RAM 16 forms a work area for temporarily storing various types of programs executed by the CPU 11, data processed by these programs, and the like.

The ROM 17 is a memory for storing data processed by the CPU 11, and the like. The ROM 17 comprises a feature value file 171, and various types of feature values calculated by the CPU 11 are stored in the feature value file 171.

The program memory 18 stores a system program, an abnormal shadow candidate detecting process program, data processed by various types of programs and the like.

Next, an operation in the present embodiment will be described.

FIG. 7 is a flowchart illustrating an abnormal shadow candidate detecting process performed by the image processing apparatus 10. In the following, an example of detecting a candidate area of mass shadow from mammography will be described.

In the abnormal shadow candidate detecting process shown in FIG. 7, first when a medical image signal is inputted from the image generating apparatus G through the I/F 12, as pre-processes of the abnormal shadow candidate detecting process, various types of image processes such as the gradation process, the unsharpness mask process, the dynamic range compressing process and the like are applied on the inputted medical image signal (Step S1). When the pre-processes are completed, the operation proceeds to a candidate detecting process of Step S2.

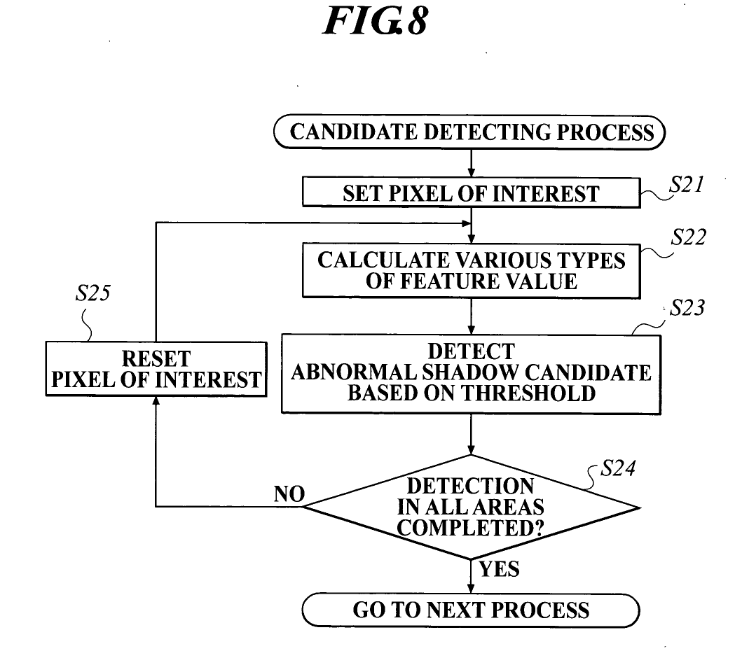

With reference to FIG. 8, a candidate detecting process will be described.

In the candidate detecting process shown in FIG. 8, first, an optional pixel of interest is set in a detection target area of an abnormal shadow candidate (an image area of mamma which is a subject) (Step S21). Then, at the set pixel of interest, a feature value of the image is calculated (Step S22).

In the present embodiment, a case to which a method using the Iris filter as a detecting algorithm of the candidate detecting process is applied will be described. In other words, a feature value such as concentration ratio of direction components and intensity components at the concentration gradient around the pixel of interest (for example, an area within a predetermined mask size) or the like is calculated. As other types of feature values, contrast, standard deviation, fractal dimension or the like around the pixel of interest are calculated.

When various types of feature values are calculated, it is compared to a threshold for the detection of an abnormal shadow candidate, which is in advance set for each feature value. Then, based on the comparison result, whether there is a high possibility of an area around the pixel of interest being abnormal shadow is judged. If it is judged that there is a high possibility of being abnormal shadow, the area around the pixel of interest is detected as a candidate area of abnormal shadow (Step S23).

Next, whether pixels of interest are set in all the detection target areas and detections of an abnormal shadow candidate are performed on all the areas is judged (Step S24). If pixels of interest are not set in all the detection target areas and therefore an undetected target area still remains (Step S24; NO), a pixel of interest is newly set in the undetected target area (Step S25), and the detection of an abnormal shadow candidate is repeated according to a reset pixel of interest.

On the other hand, if pixels of interest are set in all the detection target areas and the detection of an abnormal shadow candidate is completed (Step S24; YES), the operation proceeds to a process of Step S3 shown in FIG. 7.

In Step S3 shown in FIG. 7, whether an abnormal shadow candidate is detected in the candidate detecting process is judged. If an abnormal shadow candidate is not detected (Step S3; NO), a message which notifies that an abnormal shadow candidate is not detected is displayed on the displaying unit 13 (Step S4), and the current process is finished.

If an abnormal shadow candidate is detected in the candidate detecting process (Step S3; YES), the operation proceeds to a candidate determining process of Step S 5.

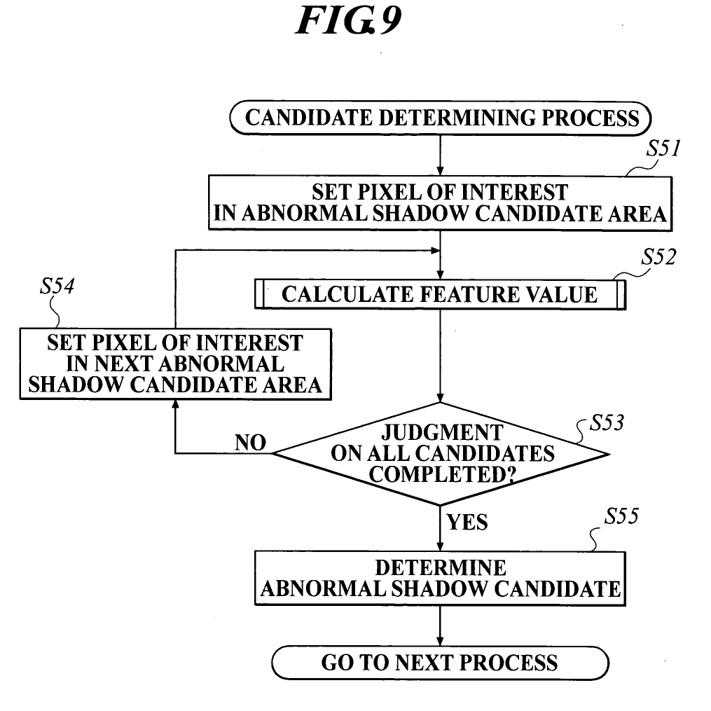

With reference to FIG. 9, the candidate determining process will be described.

In the candidate determining process shown in FIG. 9, first, a pixel located at the center of a candidate area of abnormal shadow detected by the candidate detecting process is set as a pixel of interest p (Step S51). When the pixel of interest p is set, the operation proceeds to a feature value calculating process of Step S52.

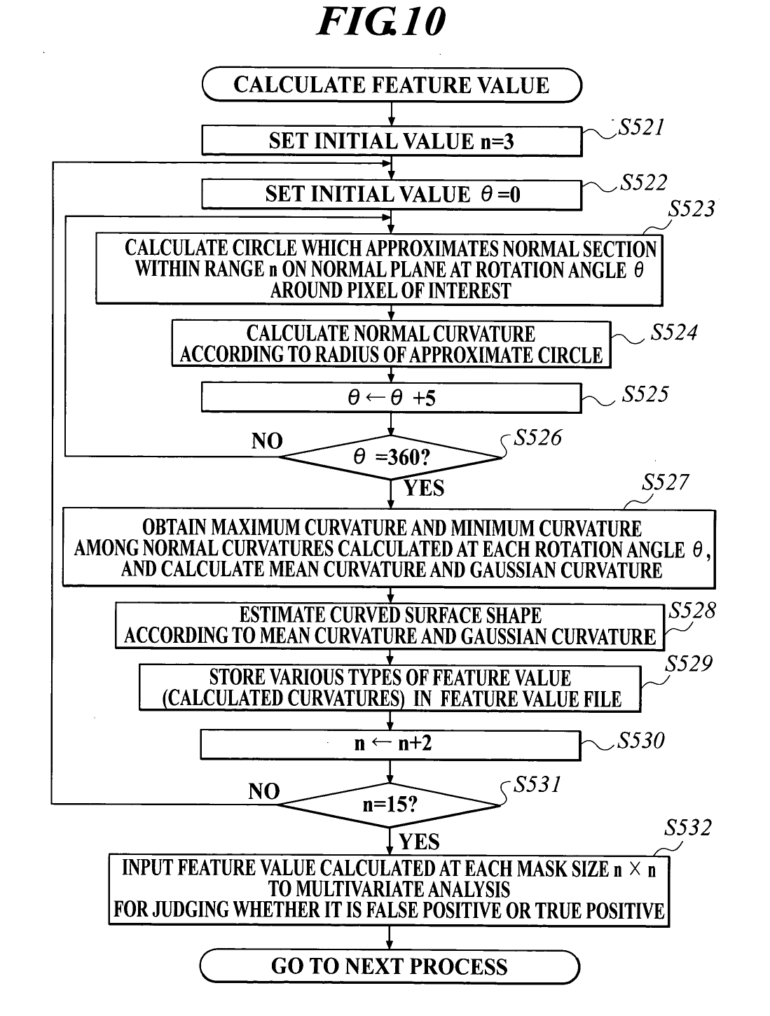

With reference to FIG. 10, the feature value calculating process of Step S52 will be described.

First, a parameter n of a range within which a normal curvature at the pixel of interest p is to be calculated is set as n=3 (Step S521), and a rotation angle θ of a normal plane F at the pixel of interest p is set as θ=0, as an initial value (Step S522).

When each parameter is set, the normal plane F at the pixel of interest p is set at the location corresponding to the rotation angle θ, and a normal section J is determined. Then, by using image signals within the range n around the pixel of interest p among image signals on the normal section J, a circle which approximates the normal section J is calculated (Step S523). Since the parameters are set as the initial values that are n=3 and θ=0 in the first routine, on the normal section J determined by the normal plane F located at the rotation angle θ =0, the CPU 11 calculates a circle which approximates image signals passing three pixels including the pixel of interest p as its center, that is, the three pixels are the pixel of interest p itself and both the adjacent pixels thereof.

Next, a radius of the calculated approximate circle is obtained, and according to the above-mentioned equation (1) and the value of the radius, a normal curvature kₙ(θ) at the rotation angle θ is calculated (Step S524). When the normal curvature is calculated, a value of θ+5 is assigned to the parameter θ of the rotation angle (Step S525), that is, the setting is changed so as to increase the rotation angle as much as 5 degree. When the setting of the rotation angle is changed,.whether a value of the rotation angle θ reaches 360 is judged (Step S526).

If the normal plane has not yet been rotated from 0 to 360 degree for calculating the normal curvature, that is, the value of the rotation angle θ has not yet reached 360 (Step S526; NO), the operation returns to the process of Step S523, and the CPU 11 calculates a normal curvature at the rotation angle θ to which a value of θ+5 is newly assigned.

On the other hand, if normal curvatures at the pixel of interest p at each 5 degree and the normal plane F is rotated from 0 to 360 degree, that is, the value of the rotation angle θ has reached 360 (Step S526; YES), among each value of the normal curvature kₙ(θ) at each rotation angle θ, the maximum value of kₙ(θ) is calculated as a maximum curvature kₙ₁, and the minimum value of kₙ(θ) is calculated as a minimum curvature kₙ₂. Then, by using the calculated maximum curvature kₙ₁ and the minimum curvature kₙ₂, according to the equations (3) and (4), a mean curvature Hₙ and a Gaussian curvature Kₙ are calculated (Step S527).

Next, based on the calculated mean curvature Hₙ and Gaussian curvature Kₙ, a curved surface shape of the density distribution is estimated (Step S528). For example, If a mean curvature Hₙ>0 and a Gaussian curvature Kₙ>0, a curved surface shape is estimated as a reentrant type based on the shape classification table shown in FIG. 6.

Next, the calculated various types of curvatures, such as a normal curvature kₙ(θ), a maximum curvature kₙ₁, a minimum curvature kₙ₂, a mean curvature Hₙ and a Gaussian curvature Kₙ are stored in the feature value file 171 as a feature value calculated within a range of a mask size n×n (Step S529).

When the feature value is stored, a value of n+2 is assigned to the parameter n of a range for calculating the various types of curvature (Step S530), and thereby a mask size is set one scale larger. When the setting of the parameter n is changed, whether a value of n reaches 15, which is set as the maximum range according to mass shadow regarded as a detection target (step S531). If a value of n does not reach 15 (Step S531; NO), the operation returns to the process of Step S522, and the various types of curvatures are calculated within the changed mask size n×n.

On the other hand, the various types of curvatures are calculated within each mask size of which a range n is sequentially widened as 3×3, 5×5, 7×7, . . . , and if a value of n reaches 15, which is the maximum range (Step S531; YES), calculation of the various types of curvatures at the pixel of interest p is completed, and the feature value calculated within each mask size n×n (a normal curvature kₙ(θ) calculated at each rotation angle θ, a maximum curvature kₙ₁, a minimum curvature kₙ₂, a mean curvature Hₙ and a Gaussian curvature Kₙ) is inputted to the multivariate analysis. Then, as a result of the multivariate analysis, based on an outputted index value, whether the area of a mask size n×n around the pixel of interest p is true positive abnormal shadow or false positive abnormal shadow is judged (Step S532).

For example, if an index value outputted by the multivariate analysis is higher than a threshold value, it is judged that there is a high possibility of being true positive abnormal shadow. On the contrary, if an outputted-index value is lower than a threshold value, it is judged that there is a high possibility of being false positive abnormal shadow. Then, after whether it is true positive or false positive is judged, the operation proceeds to Step S55 shown in FIG. 9.

In Step S55, the CPU 11 detects whether the judgment of true positive or false positive on all the candidate areas of abnormal shadow that are detected by the candidate detecting process is completed (Step S53). If the judgment on all the candidate areas is not completed (Step S53; NO), a pixel of interest is set at the center of a candidate area of an abnormal shadow candidate corresponding to a next detection target (Step S54), and the operation proceeds to the process of Step S52 to repeat the calculation of the feature value and the judgment of true positive or false positive.

On the other hand, if the judgment on all the abnormal shadow candidates is completed (Step S53; YES), based on a judgment result of being true positive or false positive, a candidate judged as false positive is eliminated from the abnormal shadow candidate detected by the candidate detecting process, and an abnormal shadow candidate judged as true positive is determined as a conclusive detection result (Step S55).

In this way, when an abnormal shadow candidate is determined, the operation proceeds to Step S 6 of FIG. 7. In Step S 6, an abnormal shadow candidate determined by the candidate determining process is displayed. Concretely, a medical image is displayed on the displaying unit 14, and over the medical image, a candidate area which is conclusively determined as an abnormal shadow candidate through the candidate detecting process and the candidate determining process is displayed so as to indicate the determined candidate area with an arrow. Alternatively, over the medical image, the candidate area is displayed with a color or the like so as to distinguish the candidate area. Further, a curved surface shape of density distribution estimated with respect to the candidate area of the detected abnormal shadow is displayed together with the detection result of an abnormal shadow candidate.

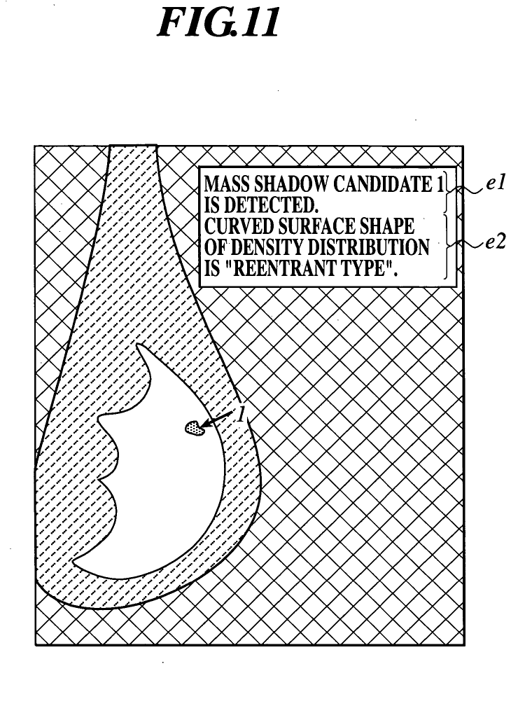

FIG. 11 shows a display example of the detection result of abnormal shadow.

FIG. 11 is a mammography in which an abnormal shadow candidate of mass detected within an image area of a mamma (subject) is displayed so as to point out the abnormal shadow candidate with an arrow as a candidate 1. Further, also the figure displays a message e1 “MASS SHADOW CANDIDATE 1 IS DETECTED” indicating that the detection target is mass on a location which does not overlap the subject image, and a message e2 “CURVED SURFACE SHAPE OF DENSITY DISTRIBUTION IS “REENTRANT TYPE” indicating that a curved surface shape of density distribution in a candidate area of the detected mass shadow candidate 1 is estimated as “reentrant type”.

In this way, in a curved surface of density distribution formed by image signals, a pixel of interest p is set. Then, as feature values within a predetermined range around the pixel of interest p, that is, a mask size n×n, various types of curvatures that are a normal curvature kₙ(θ), a maximum curvature kₙ₁, a minimum curvature kₙ₂, a mean curvature Hₙ, and a Gaussian curvature Kₙ are calculated. Then, whether it is true positive abnormal shadow or not is judged with the use of the calculated feature values. Therefore, it is possible to distinguish abnormal shadow from normal tissue by accurately detecting an image area of abnormal shadow having characteristic density distribution.

In particular, in mammography, since linear normal tissue such as mammary gland or the like can have various size of thickness, there is a case where it is difficult to distinguish shadow of mammary gland being thick block from that of mass having high circularity or that of clustered-microcalcification having rounded spread. However, by calculating curvatures, it is possible to classify a linear tissue such as mammary gland or the like as a valley type, and to classify mass and clustered-microcalcification as a reentrant type. Therefore, it is possible to prevent from detecting false positive shadow such as linear normal tissue or the like by mistake, and thereby it is possible to improve the detection accuracy.

Further, a mask size within which curvatures are to be calculated is changed, and by using various types of curvatures calculated within each changed mask size, an abnormal shadow candidate is detected. Therefore, it is possible to do the detection in consideration with a size of abnormal shadow, and thereby it is possible to handle shadow having various types of sizes.

For example, while mass shadow likely has a size approximately from 5 mm to 3 cm, clustered-microcalcification shadow has a size approximately from 200 μm to 1 mm, which is considerably smaller than that of mass shadow. Therefore, when mass shadow is to be detected, a mask size is changed up to 3 cm at maximum, and when clustered-microcalcification is to be detected, a mask size is changed up to 1 mm at maximum. Thereby, it is possible to handle abnormal shadow as a detection target.

In particular, while clustered-microcalcification shadow appears on an image with certain sizes of spread including spotted high-frequency calcification parts, noise locally appears on an image as very highly frequent shadow. Therefore, by judging whether it is true positive abnormal shadow or not with a range within which curvatures are to be calculated gradually widen up, it is possible to distinguish true positive abnormal shadow such as clustered-microcalcification having regional characteristic of area distribution from false positive shadow such as noise or the like.

Further, by setting a mask size according to a size of a lesion type of a detection target, it is possible to detect different types of abnormal shadow with one detecting algorithm. In an earlier art, a filter specialized to a lesion type is often used, and therefore it is necessary to prepare several filters corresponding to lesion types that are regarded as detection targets. However, in the present invention, it is possible to detect a plurality of lesion types of abnormal shadow with one algorithm, and thereby it is efficient.

Further, if a detecting algorithm using the curvatures is not applied to the candidate detecting process, since all the pixels are set as a pixel of interest, certain amount of calculation time is required. However, if the detecting algorithm using the curvatures is applied to the candidate detecting process, since the curvatures are calculated by using the center of a candidate area as a pixel of interest, to be used as one of the feature values to eliminate a false positive candidate, it is possible to improve the detecting accuracy even more and to reduce the calculation time and thereby it is possible to make the calculation more efficient.

Further, curvatures are calculated by setting the center of a candidate area as a pixel of interest, the candidate area being detected by the candidate detecting process, and whether it is true positive abnormal shadow or not based on the feature values including curvatures is judged. Therefore, it is possible to improve the detecting accuracy by two steps of detections. Further, since it is possible to narrow down a detection target area according to the candidate detecting process at the time of performing the candidate determining process, it is also possible to improve the processing efficiency of the candidate determining process.

Here, the described content of the present embodiment is a suitable example for the image processing apparatus 10 to which the present invention is applied, and the present invention is not limited to the content.

For example, in the above, described is the case that the conventional detecting algorithm is applied to the candidate detecting process and the detecting algorithm using curvatures of the present invention is applied to the candidate determining process. However, the present invention is not limited to this case. The detecting algorithm using curvatures of the present invention may be applied to the candidate detecting process and another detecting algorithm may be applied to the candidate determining process. Alternatively, only the candidate detecting process may be performed according to the detecting algorithm using curvatures of the present invention.

Further, with the use of the detecting algorithm using curvatures of the present invention in conjunction with another detecting algorithm such as the Iris filter, the morphology filter or the like, feature values calculated by each detecting algorithm may be inputted to the multivariate analysis. Thereby, it is possible to detect abnormal shadow comprehensively from multilateral standpoints.

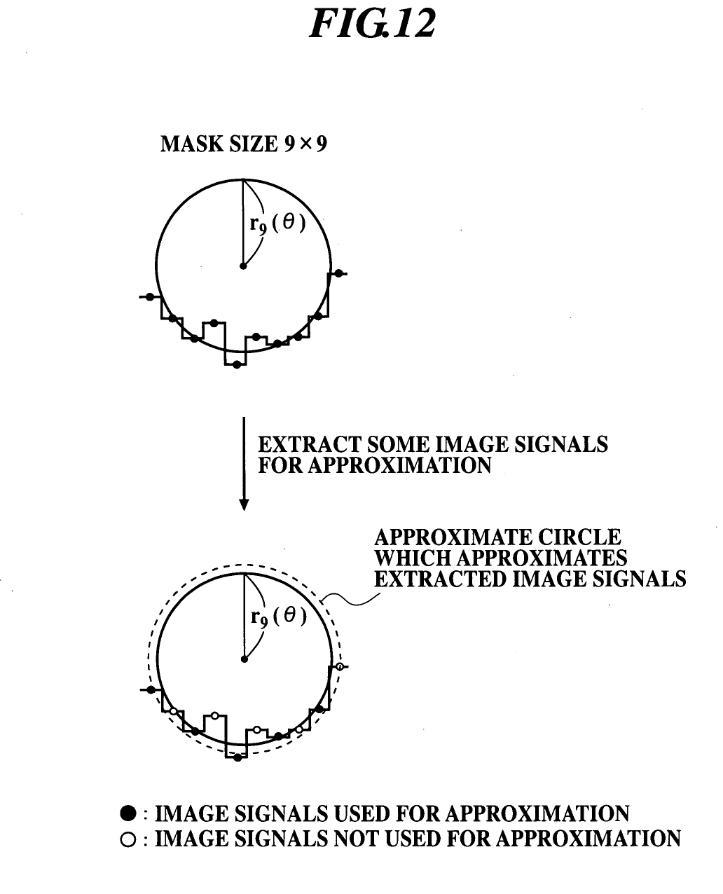

Further, in the above, described is the case where an approximate circle which approximates all the image signals within a range of a mask size n×n is calculated. However, the present invention is not limited to this case. As shown in FIG. 12, by extracting some image signals, an approximate circle may be calculated only by using the extracted image signals. In this way, by making the approximation rougher by deducting image signals to be approximated, it is possible to cut out the high frequency component of the image signals to extract the low frequency component. Therefore, by inputting curvatures calculated by using all the image signals to the multivariate analysis, and by inputting curvatures calculated by using the deducted image signals to the multivariate analysis as well, it is possible to detect an abnormal shadow candidate in consideration of frequency characteristics of the image signals.

Further, in the above, described is the case where shadow of mass or clustered-microcalcification is detected from mammography. However, the present invention can be applied to a case where, from a medical image in which another part is radiographed, abnormal shadow in the part is detected. Further, the present invention can be applied to not only a radiation image such as mammography and the like, but an ultrasound image, an MRI (Magnetic Resonance Imaging) image.

Further, if curvatures are calculated from three-dimensional signals forming a curved surface as feature values of the signals, the present invention can be applied not only to a two-dimensional medical image comprising the above-mentioned three direction components that are positions (x direction, y direction) and a density (z direction), but to other types. For example, the present invention can be applied to the sound spectrogram that comprises frequency, time and frequency spectrum, color signals comprising a brightness component, two perception chromaticity components, or the like. Thereby, it is possible to detect a signal area having a characteristic curved surface shape.

And so forth, the detailed structure and the detailed operation of the image processing apparatus 10 according to the present embodiment can be suitably changed without departing the gist of the present invention.

### Second Embodiment

In a second embodiment, what will be described is an example where an approximate function is calculated by approximating a curved surface of density distribution which is formed by medical image signals having a density direction according to the least squares method, and when curvatures of the curved surface are to be calculated as feature values by using coefficients determining the approximate function, a range of the curved surface within which the approximate function is calculated is changed, and an approximate function for each changed range is calculated for calculating the feature values.

First, a structure in the second embodiment will be described.

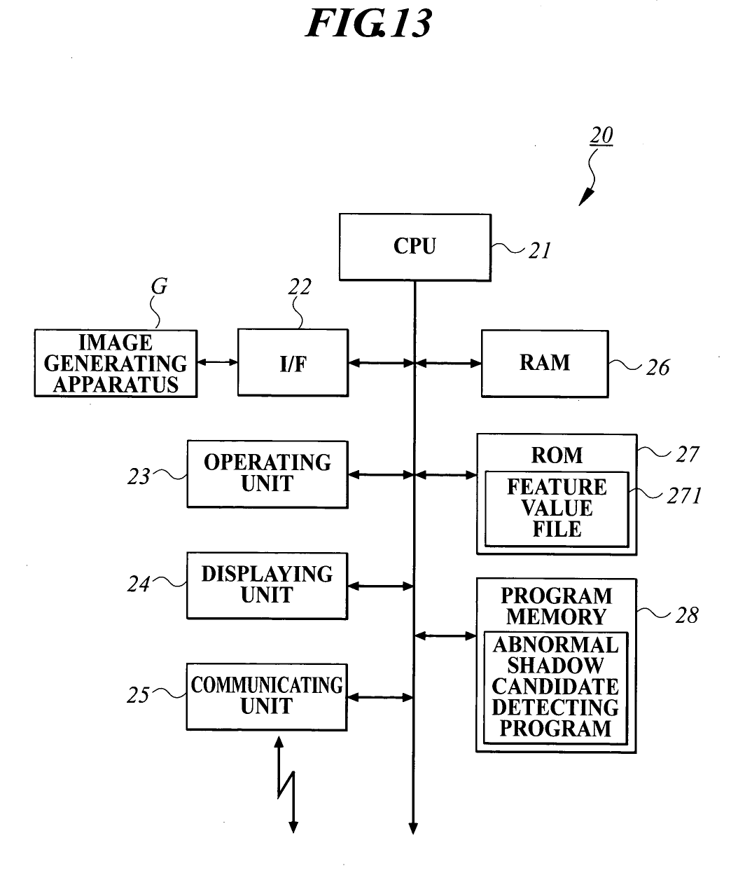

FIG. 13 shows a functional structure of a signal processing apparatus 20 in the second embodiment.

As shown in FIG. 13, the signal processing apparatus 20 comprises a CPU (Central Processing Unit) 21, an I/F (InterFace) 22, an operating unit 23, a displaying unit 24, a communicating unit 25, a RAM (Random Access Memory) 26, a ROM (Read Only Memory) 27, and a program memory 28.

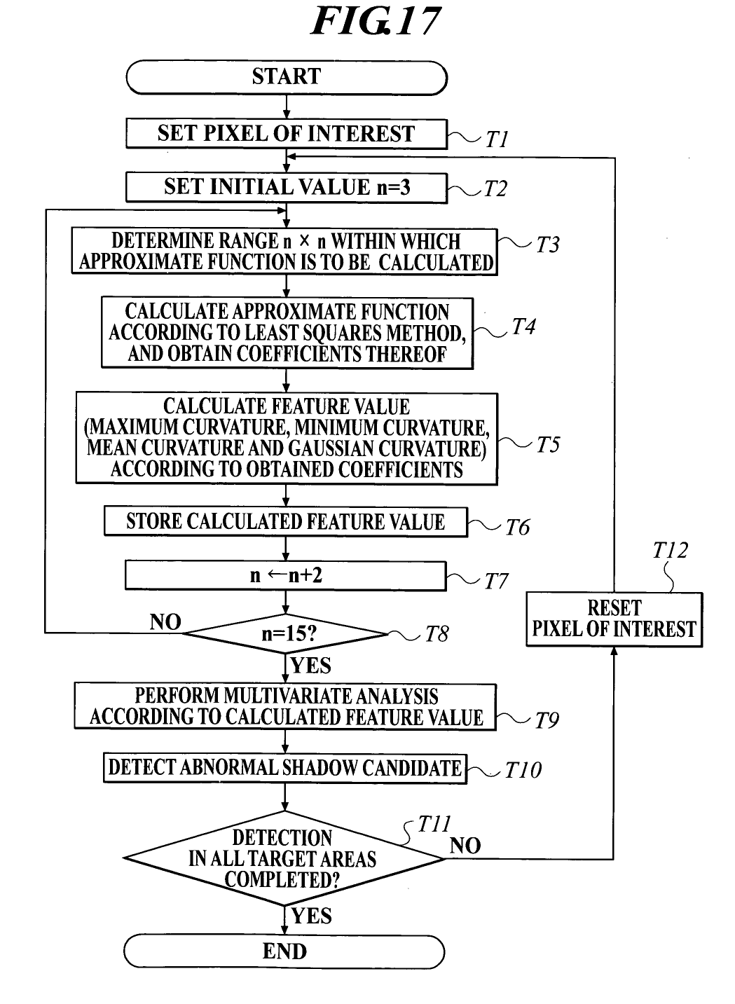

The CPU 21 develops as well as a system program stored in the program memory 28, an abnormal shadow candidate detecting process program (see FIG. 17) according to the present invention, into the RAM 26, and in conjunction with the program, the CPU 21 centrally controls each part of the signal processing apparatus 20.

In an abnormal shadow candidate detecting process, curvatures are calculated from medical image signals as the feature values, and an image area of an abnormal shadow candidate is detected by using the feature values including the curvatures.

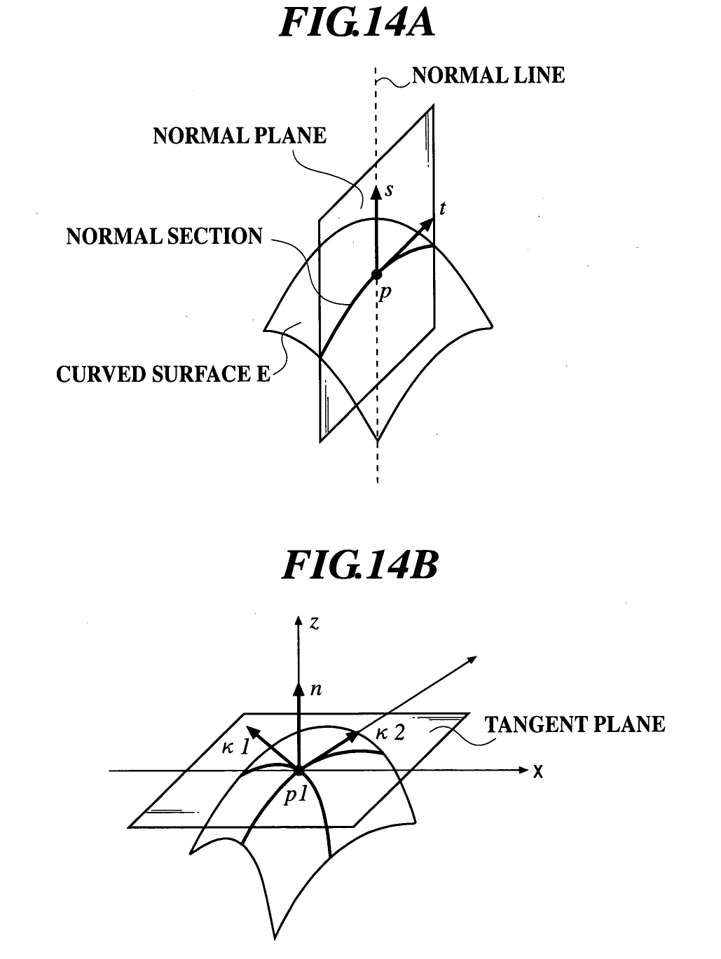

Hereinafter, with reference to FIG. 14A to FIG. 16D, calculation of the curvatures will be described in detail.

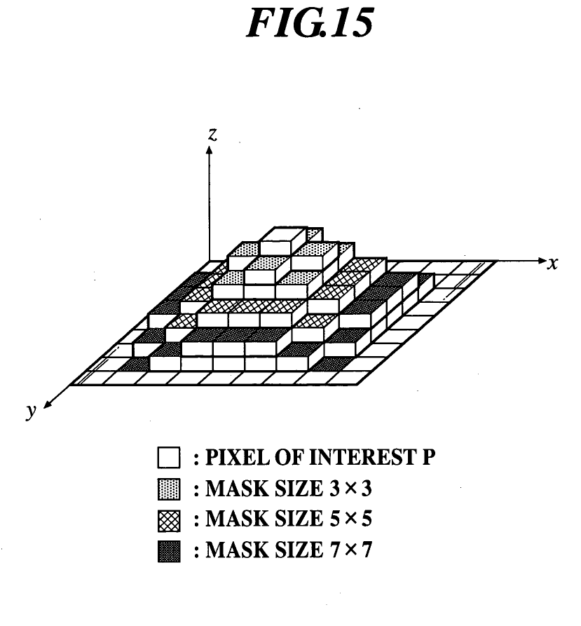

FIG. 14A is a view showing a curved surface E of density distribution according to medical image signals which comprise three directions (positions (x direction, y direction) and density (z direction)). FIG. 14B is a view showing a local coordinate system in which an optional pixel on the curved surface E is set as a pixel of interest p to be an origin, where a tangent plane at the pixel of interest p is set to be the x-y coordinate plane and a normal direction with respect to the pixel of interest p is set to be the z axis. Here, in FIG. 14A, for the convenience of description, the curved surface E is illustrated as a smooth curved surface. However, since a digital image is to be dealt with in reality, as shown in FIG. 15, the curved surface E has a stair-like shape, which indicates that each pixel has a discrete density value.

If the curved surface E is described in a local coordinate system, it is described as the following equation (4):

$$Z = \frac{1}{2} \{ {ax}^{2} + 2 bxy + {cy}^{2} \} + {O ( x , y )}^{k} \qquad ( 4 )$$

where a, b and c are constant, and O(x,y)^{k} indicates terms corresponding not more than third degree.

Further, a curvature k(θ) (curvature at the pixel of interest p on a normal section is in particular referred to as normal curvature) at the pixel of interest p on a normal section having an angle θ with respect to x axis is calculated from the following equation (5):
k(θ)=a cos²θ+2b cosθsinθ+c sin²θ

In other words, by calculating an approximate function of the curved surface E, and then by calculating each of the coefficients which are “a” for a second degree term, “b” for a first degree term and “c” for a constant term for determining the calculated approximate function, the normal curvature k(θ) can be calculated.

In the present embodiment, the curved surface E is approximated by a quadratic function according to the least squares method. In other word, the curved surface E is approximated by a quadratic surface.

In the calculation of an approximate function according to the least squares method, at first an approximate function of the curved surface E is given as a quadratic function “y=a′x²+b′x+c′”, and a mean square S which is a difference between the image signal values (x, y) and output values of the approximate function is calculated. Then, by obtaining a value by partial-differentiating the calculated mean square S with respect to each coefficient a′, b′ and c′, and by setting the partial-differentiated value to zero, the coefficients a′, b′ and c′ are calculated. Thereby the approximate function is determined.

Then, the coefficients a′ (of second degree term), b′ (of first degree term) and c′ (of constant term) obtained by approximating the curved surface E with the quadratic function “y=a′x²+b′x+c′”, according to the least squares method are assigned to a, b and c of the equation (5). Thereby, s normal curvature k(θ) is calculated.

Here, in regard to the normal curvature k(θ) at the pixel of interest p, since rotation of a normal plane with respect to the normal line changes a shape of the normal section, a value of the normal curvature k(θ) is changed correspondingly. In other words, the normal curvature k(θ) takes a maximum value and a minimum value according to a rotation angle normal θ of the normal plane. Therefore, by calculating a rotation angle θ so as to maximize k(θ), and by calculating a rotation angle θ so as to minimize k(θ), a maximum curvature k₁ and a minimum curvature k₂ are obtained.

Based on the calculated maximum curvature k₁ and minimum curvature k₂, a mean curvature H and a Gaussian curvature K can be calculated according to the following equations (6) and (7):
H=½(₁+k₂) (6)
K=k₁k₂ (7)

Based on the above-mentioned method, by using a certain pixel of interest p on the curved surface indicating density distribution as a center, the CPU 21 changes a range within which curvatures are to be calculated, that is, a mask size n×n. Then, the CPU 21 calculates an approximate function of the curved surface within each changed mask size. Then, based on coefficients of the calculated approximate function, the CPU 21 calculates various types of curvatures at each mask size n×n, such as a maximum curvature kₙ₁, a minimum curvature kₙ₂, a mean curvature Hₙ and a Gaussian curvature Kₙ (n indicates a parameter of the mask size).

For example, if medical image signals having signal distribution shown in FIG. 15 are to be processed, at first, an approximate function which approximates a curved surface with a quadratic surface within a range of a mask size 3×3 around a pixel of interest p is calculated according to the least squares method. Then, based on coefficients which determine the approximate function, each of the feature values, such as a maximum curvature kₙ₁, a minimum curvature kₙ₂, a mean curvature Hₙ and a Gaussian curvature Kₙ is calculated. Similarly, by setting a mask size n×n to 5×5, 7×7, . . . so as to widen the range from the pixel of interest p as much as one pixel at each time, a feature value is sequentially calculated.

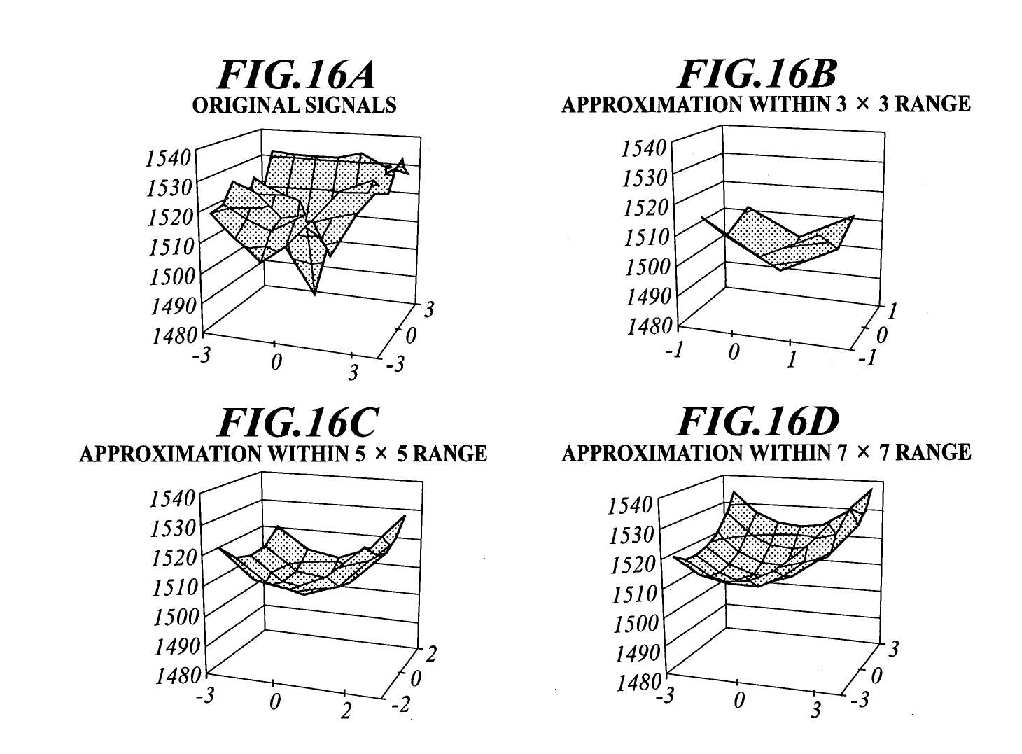

FIGS. 16A to 16D are views showing curved surfaces which are original signals and signals approximated by approximate functions calculated by changing the parameter n of a mask size as 3×3, 5×5 and 7×7. FIG. 16A is a view showing a curved surface of original signals within a range of a mask size 7×7 from a pixel of interest p, which is set as the center thereof. FIG. 16B is a view showing a curved surface which is a result of approximating the original signals at a quadratic function within a mask size 3×3, and similarly FIGS. 16C and 16D are views showing curved surfaces which are results of approximating the original signals at mask sizes 5×5 and 7×7, respectively. As shown in FIGS. 16A to 16D, as a mask size becomes larger, low frequency component affects a calculated curvature.

In this way, a mask size is widened and when calculation of the feature value up to a predetermined maximum mask size, for example 13×13, is finished, the CPU 21 assigns each feature value, such as a maximum curvature kₙ₁, a minimum curvature kₙ₂, a mean curvature Hₙ and a Gaussian curvature Kₙ calculated at mask sizes from 3×3 to 13×13, to the multivariate analysis, and judges whether there is a high possibility of being true positive abnormal shadow in an image area around the pixel of interest p. Here, the feature values including curvatures may be calculated based on a variance of k(θ) and a standard deviation of k(θ), and/or then the multivariate analysis may be-performed by using the feature values including curvatures of these values in addition to the above-mentioned curvatures.

Hereinafter, the multivariate analysis will be described.

A mean curvature H which is calculated as a feature value is a scale indicating whether the curved surface is a reentrant type or a convex type as a whole. When a value of H increases in a positive direction, the curved surface becomes more reentrant, and when a value of H increases in a negative direction, the curved surface becomes more convex. Further, a Gaussian curvature K is a scale indicating a difficulty of developing the curved surface into a plane. When the absolute value of K increases, it becomes more difficult to develop the curved surface into a plane. On the contrary, when the absolute value of K becomes closer to zero, it becomes easier to develop the curved surface into a plane.

As shown in FIG. 6, shapes of the curved surface can be classified according to a combination of a sign of a mean curvature H and a Gaussian curvature K. As shown in FIG. 6, if both K and H have positive values, a shape of the curved surface is classified as a reentrant type, if K=0 and H>0, a shape of the curved surface is classified as a half-cylinder valley type, and so on. In this way, it is possible to classify a shape of a curved surface according to a sign (positive or negative) state of values of a mean curvature H and a Gaussian curvature K.

Clustered-microcalcification and mass shadow are classified as a reentrant type. Concretely, while the reentrant shape of clustered-microcalcification seems somewhat conical, that of mass shadow seems like a smooth Gaussian distribution. Further, since shadow of mammary gland is classified as a valley type, it is possible to easily distinguish mammary gland from abnormal shadow such as clustered-microcalcification, mass and the like.

On the other hand, shadow of clustered-microcalcification has a regional characteristic so that the shadow appears on an image with spotted microcalcification parts having a size around 200 μm to 1 mm. Therefore, if a sampling pitch is set to 50 μm for example, there is a high possibility of seeing several conic density variations having a certain size. Further, since mass shadow often has a size around 5 mm to 3 cm, it is speculated that Gaussian-distribution-like density variations are seen within a range from 5 mm to 3 cm.

Therefore, the multivariate analysis is structured as follows: with respect to abnormal shadow which is known in advance, feature values such as a maximum curvature kₙ₁, a minimum curvature kₙ₂, a mean curvature H, and a Gaussian curvature Kₙ is calculated within a mask size n×n which is set according to a type thereof or a size thereof, and the calculated feature value is set as sample data in the multivariate analysis for outputting a sample value indicating how much amount of which type of abnormal shadow is contained, as an output value of the multivariate analysis. As a method of the multivariate analysis, artificial neural network, principal component analysis, discriminant analysis or the like can be cited, and any one of these may be applied, or another method may be applied.

Then, according to a sample value obtained as the result of the multivariate analysis, it is judged whether the area of a mask size n×n around the pixel of interest p is true positive abnormal shadow or not. For example, if mass shadow is defined as a detection target, the multivariate analysis is structured so as to normalize information into 0 to 1 to be outputted, the information indicating how much amount of mass shadow feature value is contained. When this index value becomes closer to 1, it indicates that a degree of having mass shadow feature value becomes larger. Then, the calculated feature value (each curvature) is assigned to the multivariate analysis for obtaining an index value from 0 to 1, and if the sample value is more than a threshold, for example 0.7, it is judged as true positive, and if the sample value is less than the threshold 0.7, it is judged as false positive.

If it is judges as true positive abnormal shadow based on a sample value, the CPU 21 detects the image area of a mask size 13×13 around the pixel of interest p as a candidate area of abnormal shadow, the image area within which a feature value is calculated. In other words, with combination of an abnormal shadow candidate detecting process program and the CPU 11, it is possible to realize the function calculating section, the feature value calculating section and the detecting section.

The I/F 22 is an interface for establishing a connection to an image generating apparatus G, and inputs medical image signals which are generated by the image generating apparatus G to the signal processing apparatus 20.

As the image generating apparatus G, for example, it is possible to apply a laser digitizer which reads medical image signals by scanning laser light over a film in which a medical image is recorded, a film scanner which reads medical image signals recorded in a film with a sensor comprising a photoelectric conversion device such as CCD (Charge Coupled Device), and the like.

Further, the method for inputting medical image signals is not limited to reading a medical image recorded in a film. A radiographing apparatus which radiographs a medical image with the use of accumulative phosphor, a flat panel detector comprising a radiation detecting device which generates electric charge corresponding to irradiated radiation and a condenser, and the like may be structured as connectable to be used for the method. After all, a method for inputting medical image signals is not specifically limited.

The operating unit 23 comprises a keyboard including cursor keys, numeric keys and various types of function keys, and outputs an operation signal corresponding to a pushed key to the CPU 21. Here, according to necessity, the operating unit 23 may comprise a pointing device such as a mouse, a touch panel or the like.

The displaying unit 24 comprises an LCD (Liquid Crystal Display) or the like, and displays various types of display information such as a medical image, a detection result of an abnormal shadow candidate by the CPU 21, and the like.

The communicating unit 25 comprises a communications interface such as a network interface card, a modem, a terminal adapter or the like, and transmits/receives of various types of information to/from an external device on the communication network. For example, a structure in which medical image signals are received from the image generating apparatus G through the communicating unit 25 is applicable, and a structure in which a detection result of an abnormal shadow candidate is transmitted through the communicating unit 25 by establishing a connection to a server within a hospital or the like, or by establishing a connection to a diagnosis terminal provided in each examination room, is applicable.

The RAM 26 forms a work area for temporarily storing therein various types of programs to be executed by the CPU 21, data processed by these programs and the like.

The ROM 27 is a memory for storing therein data processed by the CPU 21 and the like. The ROM 27 comprises a feature value file 271, and stores a feature value calculated by the CPU 21 in the feature value file 271.

The program memory 28 stores therein a system program, an abnormal shadow candidate detecting process program, data processed by various types of programs and the like.

Next, an operation in the second embodiment will be described.

FIG. 17 is a flowchart illustrating an abnormal shadow candidate detecting process performed by the signal processing apparatus 20. This process is used to calculate feature values such as curvatures or the like based on medical image signals inputted from the image generating apparatus G through the I/F 12, and to detect a signal area of an abnormal shadow candidate based on the feature value.

In the abnormal shadow candidate detecting process shown in FIG. 17, at first, an optional pixel of interest p is set in medical image signals (Step T1). Next, a parameter n of a mask size is set n=3 as an initial value (Step T2), and a mask size n×n within which an approximate function is to be calculated is determined (Step T3).

Then, a curved surface of density distribution within the range of a mask size n×n around the pixel of interest p is approximated by a quadratic function according to the least squares method, and thereby an approximate function is determined. In the first routine, since n is set to 3 as an initial value, an approximate function of the curved surface within the area of a mask size 3×3 is determined. Here, in the present embodiment, an example in which a curved surface is approximated by a quadratic function will be described. However, as long as a degree of an approximate function is the same while a mask size is changed, a fourth degree approximate function, a sixth degree approximate function and the like may be used. After all, a degree of the approximate function is not specifically limited.

After an approximate function is determined, coefficients which determine the approximate function are obtained (Step T4), and each feature value at the pixel of interest p, such as a maximum curvature kₙ₁, a minimum curvature kₙ₂, a mean curvature Hₙ, and a Gaussian curvature Kₙ, is obtained according to the obtained coefficients (Step T5). Data of each calculated feature value is stored in the feature value file 271 (Step T6).

After data of the calculated feature value is stored, a value of n+2 is assigned to the parameter n of a mask size, and thereby a mask size is changed to be set one size larger (Step T7). Next, it is judged whether n is equal to 15, that is, whether a value of n exceeds a value of 13 which is set as a maximum mask size within which an approximate function is to be calculated (Step T8). If a value of n is not equal to 15 (Step T8; NO), the operation returns to the process in Step T3, and a feature value is re-calculated within the range of a newly set mask size n×n.

On the contrary, if a value of n reaches 15 as a result of repeating calculation of a feature value within each range of mask sizes from 3×3 to 13×13 (Step T8; YES), the multivariate analysis is performed with the use of a plurality of feature values calculated within each mask size (Step T9).

When a sample value, which indicates how much amount of a feature value of abnormal shadow of a detection target is contained, is obtained as an analysis result of the multivariate analysis, the detection of an abnormal shadow candidate is performed based on the sample value (Step T10). For example, if a detection target is mass shadow, and a sample value-outputted as a multivariate analysis result is more than a threshold which is preset with respect to mass shadow, it is judged that there is a high possibility of being true positive abnormal shadow, and the range within a mask size 13×13 around the pixel of interest p is detected as an abnormal shadow candidate area. On the other hand, if the sample value is less than the threshold, it is judged that there is a low possibility of being abnormal shadow. Therefore, it is not detected as an abnormal shadow candidate, and the operation proceeds to a next process, Step T11.

In this way, feature values within predetermined ranges from a minimum mask size 3×3 to a maximum mask size 13×13 around a certain pixel of interest p are calculated. Then, when the detection of an abnormal shadow candidate is performed with the use of the feature values, it is judged whether the detection of an abnormal shadow candidate in all the detection target areas is completed (Step T11). If the detection in all the detection target areas has not been completed and therefore a detection target area still remains (Step T11; NO), a pixel of interest p′ is reset in the remaining detection target area, on which the detection has not yet been performed (Step T12), and the operation returns to the process of Step T2 for repeating the calculation of the feature values with respect to the reset pixel of interest p′. Here, a pixel of interest p′ may be sequentially set on all the pixels for detecting an abnormal shadow candidate area, or it may be sequentially set on pixels between which a predetermined interval is vacated.

On the other hand, if the detection of an abnormal shadow candidate in all the detection target areas is completed and there is no detection target area remaining for the detection (Step T11; YES), the current process is completed.

As above, a pixel of interest p is set in medical image signals which form a curved surface of density distribution, and an approximate function which approximates the curved surface of density distribution within a predetermined range around the pixel of interest p is calculated. Then, curvatures are calculated as feature values according to coefficients which determine the approximate function, to be used for detecting an abnormal shadow candidate. Therefore, it is possible to distinguish a signal area of abnormal shadow candidate which forms a characteristic curved surface shape from that of normal tissue, and thereby it is possible to detect abnormal shadow accurately.

In particular, in mammography, since linear normal tissue such as mammary gland or the like can have various sizes of thickness, there is a case where it is difficult to distinguish shadow of mammary gland being thick block, from that of mass having high circularity or that of clustered-microcalcification having rounded spread. However, by calculating curvatures to be used, it is possible to classify a linear tissue such as mammary gland or the like as a valley type as shown in FIG. 6, and to classify mass and clustered-microcalcification as a reentrant type. Therefore, it is possible to prevent from detecting false positive shadow such as linear normal tissue or the like by mistake, and thereby it is possible to improve the detection accuracy.

Further, in the second embodiment, a plurality of feature values are obtained by changing a range (mask size) within which curvatures are to be calculated around a pixel of interest p, and by calculating the curvatures within each range. Thereby, it is possible to judge comprehensively whether it is abnormal shadow or not in consideration of a spreading degree of the shadow, and thereby it is possible to handle abnormal shadow having various sizes.

For example, while mass shadow has sizes from 5 mm to 3 cm, clustered-microcalcification shadow has sizes from 200 μm to 1 mm, which is considerably smaller than that of mass shadow. Therefore, it is possible to handle abnormal shadow as a detection target by changing a mask size up to 3 cm as the maximum size when mass shadow is to be detected. Further, by changing a mask size up to 1 mm as the maximum size when clustered-microcalcification shadow is to be detected.

In particular, while clustered-microcalcification shadow appears on an image with a high-frequency calcification part having a certain size, noise locally appears as high-frequency shadow on an image. Therefore, by judging whether it is true positive abnormal shadow or not while a range within which curvatures are to be calculated is gradually widened, it is possible to distinguish true-positive abnormal shadow such as clustered-microcalcification having regional characteristic from false positive shadow, such as noise or the like.

Further, by setting a mask size according to a size of a lesion type of a detection target, it is possible to detect different types of abnormal shadow with one detecting algorithm. In an earlier art, a filter specialized for a lesion type is often used, and therefore it is necessary to prepare several filters corresponding to lesion types of detection targets. However, in the present invention, it is possible to detect a plurality of lesion types of abnormal shadow with one algorithm. Thereby it is efficient.

### Third Embodiment

In a third embodiment, what will be described is an example where an approximate function by which a curved surface of density distribution comprising medical image signals including density direction is approximated is calculated according to the least squares method, and when a feature value is calculated by using coefficients determining the approximate function, the feature value is calculated by calculating approximate function at each changed degree.

First, a structure of the third embodiment will be described.

Since an internal structure of a signal processing apparatus in the third embodiment is the same as that of the signal processing apparatus 20 in the second embodiment, identical numerals are added to the same parts for omitting description thereof, and only parts having different function will be described. In other words, the signal processing apparatus 20 in the third embodiment comprises a CPU 21, an I/F 22, an operating unit 23, a displaying unit 24, a communicating unit 25, a RAM 26, a ROM 27 and a program memory 28.

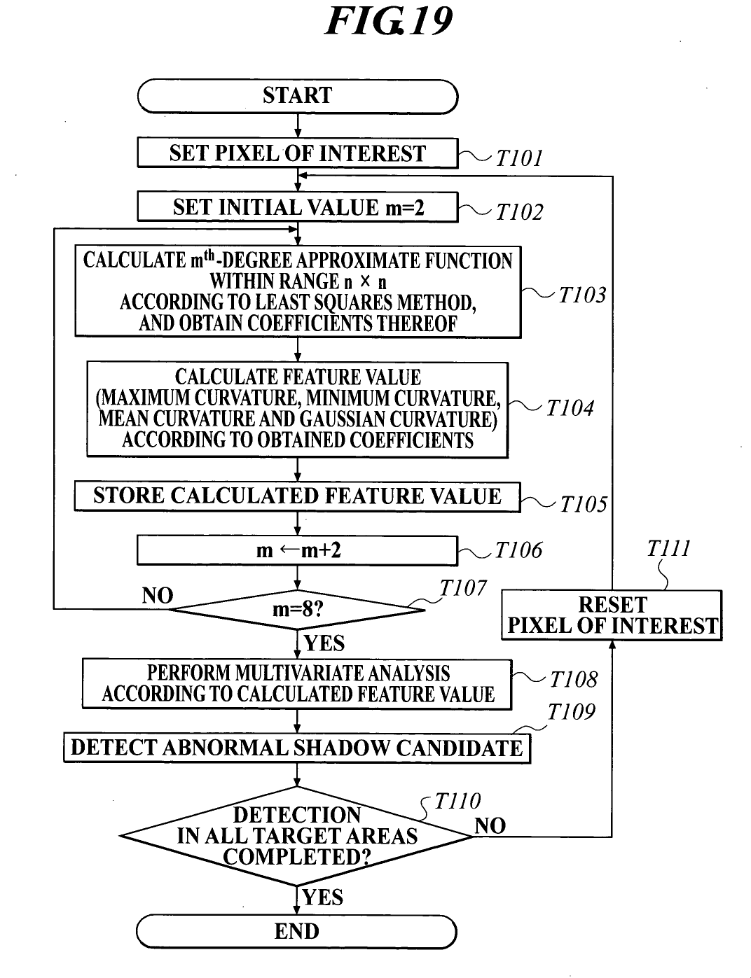

The CPU 21 develops a system program stored in the program memory 28, and an abnormal shadow candidate detecting process program according to the present invention (see FIG. 19) into the RAM 26, and centrally controls operations of each part of the signal processing apparatus 20 in conjunction with the developed program.

In an abnormal shadow candidate detecting process, curvatures are calculated as feature values from medical image signals, and a signal area of an abnormal shadow candidate is detected with the use of the feature values. Here, since a method of calculating an approximate function and a method of calculating curvatures are the same as the methods in the second embodiment, description thereof is omitted.

In the third embodiment, the CPU 21 fixes a mask size within which an approximate function is calculated when the feature values including curvatures are to be calculated. Within a predetermined mask size, for example 7×7, around a pixel of interest p on a curved surface, the CPU 21 changes a degree of an approximate function such as a quadratic function, a fourth degree function, a sixth degree function and the like, and calculates approximate functions at each degree by which the curved surface is approximated.

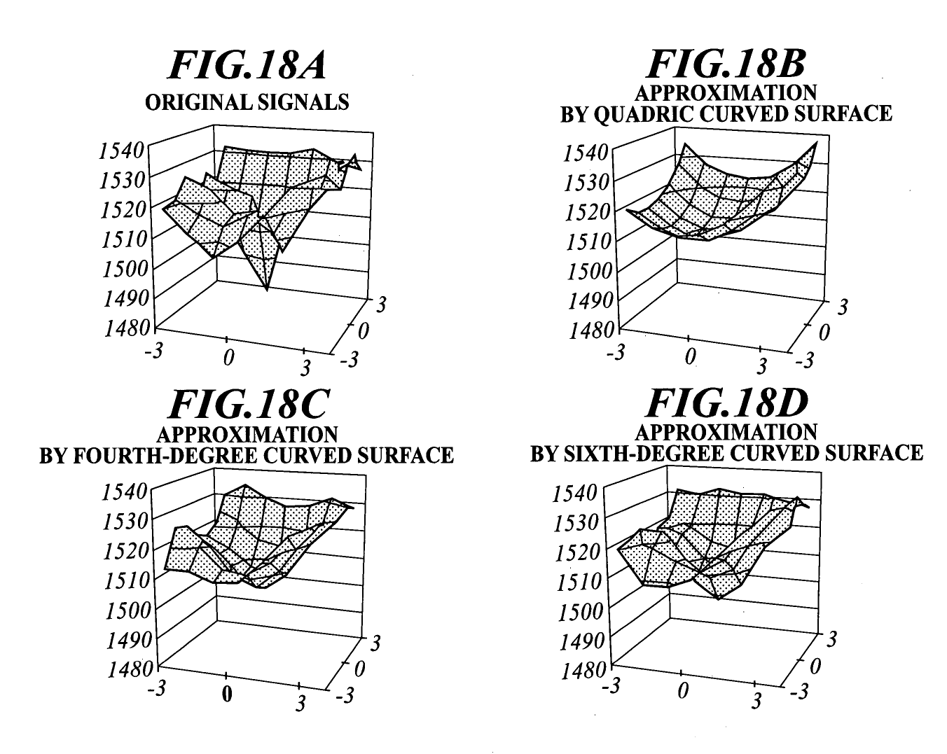

FIGS. 18A to 18D are views showing curved surfaces which are original signals and signals approximated by approximate functions in which a degree parameter m is changed as two, four and six. FIG. 18A is a view showing a curved surface of original signals within the range of a mask size 7×7 around a pixel of interest p. FIG. 18B shows a curved surface indicating a quadric approximate function which approximates the original signals, and similarly, FIG. 18C shows a curved surface of a fourth degree function which approximates the original signals and FIG. 18D shows a curved surface of a sixth degree function which approximates the original signals. As a degree of an approximate function becomes higher, approximation accuracy improves and a shape of the curved surface becomes closer to the original signals.

When approximate functions at each degree are calculated, coefficients of the second degree term a′, the first degree term b′ and the constant term c′ of the approximate functions at each degree are obtained. Then, after they are assigned to the above-described equation (5), a maximum curvature kₘ₁ and a minimum curvature kₘ₂ of a normal curvature kₘ(θ) at the pixel of interest p are calculated, and further a mean curvature Hₘ and a Gaussian curvature Kₘ are calculated as feature values (m indicates a parameter of the degree).

The CPU 21 inputs the feature values calculated from approximate functions at each degree to the multivariate analysis, for judging whether there is a high possibility of being abnormal shadow. As well as the second embodiment, the multivariate analysis is-structured as follows: with respect to abnormal shadow which is known in advance, feature values such as a maximum curvature kₘ₁, a minimum curvature kₘ₂, a mean curvature Hₘ and a Gaussian curvature Kₘ within a mask size which is set according to a type thereof or a size thereof, and the calculated feature values are set in the multivariate analysis as sample data for outputting a sample value which indicates how much amount of which type of abnormal shadow is contained, as an output value of the multivariate analysis. As a result of the multivariate analysis, if a sample value indicating that there is a high possibility of being abnormal shadow, the CPU 21 detects an image area within a predetermined mask size around the pixel of interest p as an abnormal shadow candidate area.

Next, an operation in the third embodiment will be described.

FIG. 19 is a flowchart illustrating the abnormal shadow candidate detecting process performed by the signal processing apparatus 20. This process is used to calculate feature values such as curvatures or the like from medical image signals inputted from the image generating apparatus G through the I/F 22, and to detect an abnormal shadow candidate area based on the feature values.

In the abnormal shadow candidate detecting process shown in FIG. 19, at first, an optional pixel of interest p is set on medical image signals inputted from the image generating apparatus G through the I/F 22 (Step T101). Next, a parameter m of the degree is set m=2 as an initial value, and thereby a degree m which is used for calculating an approximate function is determined (Step T102).

Next, a curved surface of density distribution within the range of a predetermined mask size n×n is approximated by an m-degree function according to the least squares method, and thereby this m-degree approximate function is determined. In the first routine, since m is set m=2 as the initial value, a second degree (quadratic) approximate function is determined.

When an approximate function is determined, each of the coefficients of the second degree term, the first degree term and the constant term of the approximate function is obtained (Step T103). Then, each feature value such as a maximum curvature kₘ₁, a minimum curvature kₘ₂, a mean curvature Hₘ and a Gaussian curvature Kₘ at the pixel of interest p is calculated with the use of the obtained coefficients (Step T104). Data of each calculated feature value is stored in the feature value file 271 (Step T105).

When the data of calculated feature value is stored, a value of m+2 is assigned to a parameter m of the degree, and a degree of the approximate function is set one scale higher (Step T106). Then, whether a value of m reached a value of 8, which is set as a maximum degree for calculating an approximate function, is judged (Step T107). If m is not equal to 8 (Step T107; NO), the operation returns to the process of Step T103, and an approximate function is re-calculated according to a newly set degree m and a feature value is calculated.

On the contrary, if a value of m reaches 8 as a result of repeating the calculation of an approximate function and feature values at each degree of second, fourth, sixth and so forth (Step T107; YES), the multivariate analysis is performed with the use of the feature values calculated by changing a degree (Step T108).

Then, when a sample value which indicates how much amount of a feature value of abnormal shadow of a detection target is contained is obtained according to the multivariate analysis, the detection of an abnormal shadow candidate is performed based on the sample value (Step T109). For example, in the case that a detection target is mass shadow, if a sample value outputted as a result of the multivariate analysis is more than a threshold which is in advance set according to mass shadow, it is judged that there is a high possibility of being true-positive mass shadow, and the range of a mask size 13×13 around the pixel of interest p is detected as an abnormal shadow candidate area. On the other hand, if the sample value is less than the threshold, it is judged there is a low possibility of being abnormal shadow. Then, it is not detected as an abnormal shadow candidate and the operation proceeds to Step T110.

In this way, a feature value within the range of a predetermined mask size around the pixel of interest p is calculated, and when the detection of an abnormal shadow candidate with the use of the feature values is completed, it is judged whether the detection of an abnormal shadow candidate in all the detection target areas is completed (Step T110). If the detection in all the detection target areas is not completed and therefore a detection target area still remains (Step T110; NO), a pixel of interest p′ is reset in the remaining detection target area on which the detection has not yet been performed (Step T111), and the operation returns to the process of Step T102 for repeating the calculation of the feature value with respect to the reset pixel of interest p′. Here, a pixel of interest p′ may be sequentially set on all the pixels for detecting an abnormal shadow candidate area, or it may be sequentially set on pixels between which a predetermined interval is vacated.

On the other hand, if the detection of an abnormal shadow candidate in all the detection target areas is completed and there is no detection target area remaining for the detection (Step T110; YES), the current process is completed.

As above, in medical image signals forming a curved surface of density distribution, a pixel of interest p is set, an approximate function which approximates the curved surface of density distribution within a predetermined range around the pixel of interest p is calculated, and curvatures are calculated as feature values according to coefficients which determine the approximate function to be used for detecting an abnormal shadow candidate. Therefore, it is possible to distinguish a signal area of an abnormal shadow candidate which forms a characteristic curved surface shape from that of normal tissue, and thereby it is possible to detect abnormal shadow accurately.

In particular, in mammography, since linear normal tissue such as mammary gland or the like can have various sizes of thickness, there is a case where it is difficult to distinguish shadow of mammary gland being thick block, from that of mass having high circularity or that of clustered-microcalcification having rounded spread. However, by calculating curvatures, it is possible to classify a linear tissue such as mammary gland or the like as a valley type, and to classify mass and clustered-microcalcification as a reentrant type. Therefore, it is possible to prevent from detecting false positive shadow such as linear normal tissue or the like by mistake, and thereby it is possible to improve the detection accuracy.

Further, in the third embodiment, a plurality of feature values are obtained by changing a degree of an approximate function which approximates a curved surface, and by calculating curvatures according to coefficients of the approximate functions at each degree. As shown in FIGS. 18A to 18D, when a degree of the approximate function increases, higher frequency component is reflected to a curved surface which is approximated by the approximate functions. Thereby, it is possible to comprehensively judge whether it is abnormal shadow based on factors including information of image signal frequency, and thereby it is possible to improve the detection accuracy of an abnormal shadow candidate.

In particular, since noise appears as high frequency shadow on an image, by changing a degree of an approximate function to identify an appearance of high frequency signals, it is possible to distinguish true positive abnormal shadow such as clustered-microcalcification and the like, from false positive abnormal shadow such as noise and the like.

Here, the described contents in the second embodiment and the third embodiment are suitable examples to which the present invention is applied, and the present invention is not limited to the contents.

For example, in the above-described example, a pixel of interest is sequentially set, feature values such as curvatures and the like around the pixel of interest is calculated, and the detection of an abnormal shadow candidate is performed with the use of the calculated feature values. However, a detection method is not limited to the example. As the first detection, the detection may be performed according to an detecting algorithm such as the Iris filter, the morphology filter or the like, and as a second detection or as a narrowing-down of the first detection, the detection may be performed within a range detected by the first detection according to the detecting algorithm with the use of curvatures of the present invention. If curvatures are used in the first detection, since all the pixels are to be pixels of interest, it is necessary to have some amount of calculation time. However, if curvatures are used in the second detection, since the curvatures are calculated by using the center of a candidate as a pixel of interest and it is possible to use the curvature as one of the feature values for eliminating a false positive candidate, the detection accuracy becomes even higher, and it is possible to do the calculation efficiently with the calculation time reduced.

Further, with the combination of the detecting algorithm using the curvatures of the present invention and another detecting algorithm such as the Iris filter, the morphology filter or the like, it may be judged whether it is abnormal shadow or not by inputting the feature values including the curvatures and various types of feature values such as a feature value calculated according to each detecting algorithm, concentration ratio of density inclination calculated by the Iris filter, circularity of shadow, a size of the shadow or the like, to the multivariate analysis. In this way, it is possible to make a comprehensive judgment.

Further, in the above, described is the example that shadow such as mass shadow, clustered-microcalcification shadow or the like is to be detected from mammography. However, it is possible to apply the present invention to a case of detecting abnormal shadow of another part from a medical image in which the corresponding part is radiographed. Further, the present invention is not limited to a radiation image such as mammography and the like. The present invention may be applied to an ultrasonogram, an MRI image and the like.

Further, if curvatures are calculated at the time of analyzing three-dimensional signals having the three-dimensional components and the curvatures are defined as feature values of the signals, the present invention may be applied not only to the above-mentioned medical image signals, which comprises three direction components of location (x direction, y direction) and density (z direction), but also to sound spectrogram which comprises three axes (frequency, time and frequency spectrum), to color signals which comprises a brightness component and two chromaticness components and the like.

Further, in the third embodiment, described is the case that a value of m+2 is assigned to a parameter m of the degree for setting a degree of the approximate function one scale higher. However, the present invention is not limited to this case. For example, a value of m+1 may be assigned to a parameter m of the degree for setting a degree of the approximate function one scale higher.

And so forth, the detailed structure and the detailed operation of the signal processing apparatus 20 in the second embodiment and the third embodiment may be suitably changed without departing the gist of the present invention.

The entire disclosure of Japanese Patent Applications No. Tokugan 2003-313882 filed on Sep. 5, 2003 and No. Tokugan 2003-313855 filed on Sep. 5, 2003, including specifications, claims, drawings and summaries are incorporated herein by reference in their entirety.

1. An image processing apparatus comprising a feature value calculating section for setting a certain pixel in a processing target image as a pixel of interest, and for calculating a curvature of a curved surface which is obtained from density distribution of adjacent pixels which are located within a predetermined range from the pixel of interest, as a feature value of an image area within the predetermined range from the pixel of interest.

2. The apparatus of claim 1, wherein
the processing target image comprises a medical image,
the feature value calculating section sets each pixel of the medical image as the pixel of interest, and calculates each curvature with respect to each pixel of interest as the feature value, and
the apparatus comprises an abnormal shadow candidate detecting section for detecting an area within the predetermined range from the pixel of interest as a candidate area of abnormal shadow, based on the feature value including each curvature calculated by the feature value calculating section with respect to each pixel of interest.

3. The apparatus of claim 1, wherein
the processing target image comprises a medical image,
the apparatus comprises an abnormal shadow candidate detecting section for detecting a candidate area of abnormal shadow of the medical image,
the feature value calculating section sets the pixel of interest within the candidate area of the abnormal shadow detected by the abnormal shadow candidate detecting section and calculates the curvature, and
the apparatus comprises an abnormal shadow candidate determining section for judging whether the candidate area of the abnormal shadow detected by the abnormal shadow candidate detecting section is true positive or not based on the feature value calculated by the feature value calculating section, and for outputting all candidate areas which are judged true positive as a detection result of an abnormal shadow candidate.

4. The apparatus of claim 3, wherein
the feature value calculating section sets a center of the candidate area of the abnormal shadow detected by the abnormal shadow candidate detecting section as the pixel of interest, and calculates the curvature thereof, and
the abnormal shadow candidate determining section judges whether the candidate area of the abnormal shadow detected by the abnormal shadow candidate detecting section is true positive or not, based on the curvature calculated by the feature value calculating section.

5. The apparatus of claim 1, wherein the feature value calculating section changes a range of the curved surface, within which the feature value including the curvature is to be calculated, and calculates curvatures within each changed range.

6. The apparatus of claim 5, wherein the feature value calculating section calculates all the curvatures corresponding to each changed range as the feature value.

7. The apparatus of claim 5, wherein the feature value calculating section calculates at least one of the curvatures corresponding to each changed range as the feature value.

8. The apparatus of claim 2, wherein the feature value calculating section changes a range of the curved surface, within which the feature value is to be calculated, according to at least one of a type and a size of abnormal shadow to be detected.

9. The apparatus of claim 1, wherein, by using a normal line at the pixel of interest as an axis, the feature value calculating section rotates a normal plane determined by the normal line as much as a predetermined angle, and the feature value calculating section calculates an approximate circle which approximates a curved surface shape which is cut out from the curved surface by the normal plane within the predetermined range from the pixel of interest, and the feature value calculating section calculates the curvature based on a radius of the approximate circle.

10. The apparatus of claim 9, wherein, when the approximate circle is to be calculated, pixels are extracted among all pixels that form the curved surface within the predetermined range, and the approximate circle is calculated by using the extracted pixels.

11. The apparatus of claim 9, wherein the feature value calculating section calculates all curvatures calculated from the rotated normal plane at each rotation angle as the feature value.

12. The apparatus of claim 9, wherein the feature value calculating section calculates at least one of curvatures calculated from the rotated normal plane at each rotation angle as the feature value.

13. The apparatus of claim 1, wherein the feature value calculating section sets the pixel of interest in all image areas of the processing target image to calculate the feature value.

14. The apparatus of claim 1, further comprising:
an estimating section for estimating a curved surface shape based on the feature value including the curvature calculated by the feature value calculating section; and
a notifying section for giving information of the estimated curve shape.

15. A signal processing apparatus comprising:
a function calculating section for setting a certain signal among processing target signals which form a curved surface as a signal of interest, and for calculating an approximate function which approximates the curved surface within a predetermined range from the signal of interest; and
a feature value calculating section for calculating a feature value of signals within the predetermined range, within which the approximate function is to be calculated, based on a coefficient which determines the approximate function calculated by the function calculating section.

16. The apparatus of claim 15, wherein
the function calculating section calculates a plurality of approximate functions which approximate the curved surface within the predetermined range from the signal of interest, and
the feature value calculating section calculates the feature value from each of the calculated plurality of approximate functions.

17. The apparatus of claim 16, wherein
the function calculating section changes a range within which the plurality of approximate functions are to be calculated and calculates the plurality of approximate functions within each changed range, and
the feature value calculating section calculates the feature value from each of the calculated plurality of approximate functions within each range.

18. The apparatus of claim 16, wherein
the function calculating section changes a degree for calculating the plurality of approximate functions corresponding to each changed degree, and
the feature value calculating section calculates the feature value from each of the calculated plurality of approximate functions corresponding to each degree.

19. The apparatus of claims 15, wherein the feature value calculating section calculates a curvature as the feature value, from a coefficient of the approximate function calculated by the function calculating section.

20. The apparatus of claim 19, wherein the feature value calculating section calculates the curvature and calculates information regarding the calculated curvature to be used as the feature value.

21. The apparatus of claims 15, wherein the function calculating section calculates the approximate function according to a least squares method.

22. The apparatus of claim 21, wherein the approximate function calculated by the function calculating section according to the least squares method comprises a multidimensional polynomial function.

23. The apparatus of claim 22, wherein the feature value calculating section calculates the feature value by using at least one of or all of coefficients of a second degree term, a first degree term and a constant term of the multidimensional polynomial function.

24. The apparatus of claims 15, wherein the processing target signals comprise image signals.

25. The apparatus of claim 24, wherein the image signals comprise medical image signals.

26. The apparatus of claim 24, further comprising a detecting section for detecting a signal area which forms a curved surface in a Gaussian distribution or in a conic structure fashion, by using the feature value calculated by the feature value calculating section.

27. The apparatus of claim 25, further comprising a detecting section for detecting a signal area which forms a curved surface in a Gaussian distribution or in a conic structure fashion, by using the feature value calculated by the feature value calculating section.

28. The apparatus of claim 27, wherein the detecting section detects a signal area of a mass shadow candidate from the medical image signals, by using the feature value calculated by the feature value calculating section.

29. The apparatus of claim 27, wherein the detecting section detects a signal area of a clustered-microcalcification shadow candidate from the medical image signals, by using the feature value calculated by the feature value calculating section.
